(19) United States
(12) Patent Application Publication
(10) Pub. No.: US 2014/0116320 A1
(43) Pub. Date: May 1, 2014

(54) Earthquake Alarm

(71) Applicant: Gabriel Curiel, Torreon (MX)

(72) Inventor: Gabriel Curiel, Torreon (MX)

(21) Appl. No.: 13/662,364

(22) Filed: Oct. 26, 2012

(51) Int. Cl. G01V 1/00

(52) U.S. Cl. 116/200

(57) ABSTRACT

This invention relates generally to earthquake detectors, and specifically to the use of a plurality of vertically and/or horizontally fixed-position acoustic elements, such as tubular bells or chimes radially disposed in spaced-apart relationship around their own striker pendulum to emit sounds audible to a human in the event of an earthquake. In one embodiment of the present invention there is disclosed a combination vertically- and horizontally-oriented earthquake detection system comprising: a frame structure, one or more vertical acoustic units, and one or more horizontal acoustic units. The acoustic units employ a plurality of acoustic elements radially disposed (either in horizontally or vertically) about a pendulum striker device. Other embodiments include a vertically-oriented earthquake detection system employing only vertical acoustic units, and a horizontally-oriented system employing only horizontal acoustic units. The system moves with the earthquake movements to cause interplay between the striker and the acoustic elements.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

1. Field of the Invention

This invention relates generally to earthquake detectors, and specifically to the use of a plurality of vertically and/or horizontally fixed-position acoustic elements, such as tubular bells or chimes radially disposed in spaced-apart relationship around their own striker pendulum. The present invention provides a great deal of flexibility in designing alarms that are sensitive to varying magnitudes of earthquakes. The size, dimensions, thicknesses and acoustic qualities of the acoustic elements, along with the variations of striker pendulums allow the detector to activate when the earthquake has just begun with a small magnitude. As the intensity of the earthquake increases, the alarm sound increases. This invention also provides a combination system for detecting both trepidatory and oscillatory earthquakes by employing horizontally and vertically oriented acoustic elements.

2. Description of the Prior Art

Earthquake detection, especially in those particular geographical areas of the world that are especially prone to earthquakes, has been essential for the safety and well-being of building occupants. A plurality of sophisticated devices have been devised in the last few years which employ either electrical AC current or battery-operated power that are used for seismic-type energy detection in order to set off a particular earthquake alarm. In addition to the complex detecting devices, typically audio devices with speakers and other complex electrical equipment may be employed, all of which is costly and not always operable if, for example, there is a power outage and any batteries employed are not operational.

U.S. Pat. No. 4,262,289 (Rivera), shows a seismic tremor sensor alarm which utilizes a battery-powered device with contact points and the like. U.S. Pat. No. 5,001,466 (Orlinsky, et al.), shows an earthquake detector that includes a battery power source, detection circuitry, and an alarm. The use of batteries and battery-powered equipment for something as critical as earthquake detection has a serious drawback that, since no one knows for sure at any given moment when an earthquake might occur, constant vigilance would be required to insure that the batteries are connected. If a direct power source were used such as found in outlets in a typical residence or business, there is no guarantee that the earthquake itself might not take out power lines and power sources.

U.S. Pat. No. 5,764,154 (Hutchings), shows an earthquake alarm that does not require batteries or other external power supply that supplies an audio alert with sound waves that can be detected by a human being, particularly useful in a bedroom to awaken a human being to notify them of an earthquake, comprising a plurality of sound-generating members, mechanically disposed extremely close together (at least within one-half inch of each other) and tethered from a frame that is supported from the ceiling so that upon vibration of the ceiling, the sound generating members will be vibrated and bump into each other, causing a large amount of sound, which can readily wake someone up. In order to prevent inadvertent alarm signals because of wind currents, a wind deflector or shield is placed around the device to prevent wind from striking the device.

Earthquakes are divided into two basic types: oscillatory (horizontal movement) and trepidatory (vertical movement) and typically, there is not a unique, perfect division between oscillatory and trepidatory movement during an earthquake event. During an earthquake, one form of movement may be the dominant movement, while the other form of movement may not be present. Also, both forms of movement could be present for an earthquake.

Therefore, there continues to be a need for a simple, non-electrical earthquake detection system that can detect earthquakes based on the type of movement exerted by the earthquake.

### BRIEF SUMMARY OF INVENTION

In one embodiment of the present invention there is disclosed a combination vertically- and horizontally-oriented earthquake detection system comprising: a frame structure, one or more vertical acoustic units, and one or more horizontal acoustic units. In one embodiment, the frame structure or housing comprises: a substantially horizontally-oriented base member, a top support member spaced apart from the base member, and one or more substantially vertical support members connected between the top support member and the base member. The overall frame members could generally form a rectangular shape, a tetrahedron, a triangular shape or the like.

In one embodiment, the vertical acoustic unit comprises a plurality of vertical acoustic elements, each having opposed upper and lower ends and an external striking surface capable of emitting a sound audible to humans when impacted by a pendulum striker. A support structure can be employed for mounting the plurality of vertical acoustic elements to the housing/frame in a location between the top support member and the base member, the plurality of vertical acoustic elements being positioned in a substantially vertical orientation in a spaced-apart relationship at a radial distance from a first centerpoint to form a substantially cylindrical array of vertically-oriented acoustic elements. The external striking surfaces of the plurality of mounted vertical acoustic elements are directed towards the first centerpoint. The vertical acoustic unit further comprises a pendulum comprising a cord having an upper cord end and a lower cord end defining a cord length, the upper cord end being attached to an attachment point on the top support member directly above the first centerpoint. A pendulum striker is attached to the lower cord end, the striker having a desired mass and external surface capable of causing one or more of the plurality of vertical acoustic elements to emit a sound audible to humans upon impacting the external striking surface of the one or more of the plurality of vertical acoustic elements. The cord length is sufficient to permit the pendulum striker to impact one or more of the striking surfaces of the vertical acoustic elements.

In one embodiment, the horizontal acoustic unit comprises a plurality of horizontal acoustic elements, each having opposed ends and an external striking surface capable of emitting a sound audible to humans when impacted by a pendulum striker. A support structure can be employed for mounting the plurality of horizontal acoustic elements to the housing/frame, the plurality of horizontal acoustic elements being positioned in a substantially horizontal orientation relative to the one or more substantially vertical support members in a spaced-apart relationship at a radial distance from a second centerpoint to form a substantially cylindrical array of horizontally-oriented acoustic elements. The external striking surfaces of the plurality of mounted horizontal acoustic elements are directed towards the second centerpoint. The horizontal acoustic unit further comprises a pendulum comprising a flexible rod having an first rod end and a second rod end defining a rod length, the first rod end being attached to an attachment point on one of the one or more substantially vertical support members in coaxial relationship with the cylindrical array of horizontally-oriented acoustic elements along the second centerpoint. A pendulum striker is attached to the second rod end, the striker having a desired mass and external surface capable of causing one or more of the plurality of horizontal acoustic elements to emit a sound audible to humans upon impacting the external striking surface of the one or more of the plurality of horizontal acoustic elements. The rod length is sufficient to permit the pendulum striker to impact one or more of the striking surfaces of the horizontal acoustic elements.

The earthquake detection systems of the present invention may comprise more than one vertical acoustic unit and/or more than one horizontal acoustic units. The acoustic units may be of different sizes or the same size. The design of the acoustic units may vary in dimensions and specifications such as, for example: the diameters and length of the chimes, the diameters and thickness of the tubes, the length of the pendulum wire, cord and/or rod, the size and weight of the pendulum striker, and so on. These variations will allow use of a plurality of different acoustically tuned chimes such that the sound of different chimes become activated in a gradual way as the time of the earthquake magnitude increases, so at the beginning of the earthquake it will sound only one chime (or chimes tuned to low earthquake magnitude), and when the earthquake has intensified in its magnitude, the alarm will sound two or three chimes (or those chimes tuned to higher earthquake magnitudes), and finally when the earthquake had finally reached it maximum magnitude, four or five chimes will sound (or those chimes tuned to high earthquake magnitudes). Because earthquakes can have a duration of less than 1 minute to 3 minutes or more, the gradual way in which this embodiment detects earthquakes allows those in proximity to the alarm to receive the first warning sign with any small movement of land, drawing their attention and alerting them as the magnitude of the earthquake and number of chimes playing increases in the earthquake detector. For example, this earthquake detector could be tuned to be triggered to sound the first chime for vibrations as low as those created by the passage of a train or heavy trailer on the street next to an apartment building, so that the earliest stages of an earthquake will immediately be called to the attention of building occupants.

The vertical acoustic elements and horizontal acoustic elements may be selected from the group consisting of tubes, tubular chimes, bells, solid rods, bars and other acoustic structures. The acoustic elements may be constructed out of any acoustic materials, including, for example metals, metal alloys, steel, copper, aluminum, high-copper alloys, duraluminum, wood, hardwood, Honduran Rosewood, Cardinal wood, Purpleheart wood, African Padouk, Oak, Durian, Meranti, glass, ceramic materials, synthetic thermoplastic materials, glass fiber reinforced synthetic materials, and ceramic reinforced synthetic materials and the like.

To one of ordinary skill in the art having the benefit of the present disclosure, there are numerous ways in which the acoustic elements can be mounted. For example, in one embodiment of the present earthquake detection system, the vertical acoustic elements and horizontal acoustic elements are mounted to their respective support structures in a manner that minimizes any damping of the audible sound emitted from the acoustic elements.

In one embodiment, the vertical acoustic elements and horizontal acoustic elements are metal tubular chimes, cylindrical containers, or rods made of different materials, each chime having one or more nodal points that may serve as points of attachment for attaching the acoustic elements to the support structure. The support structure and tubular chime could be coaxial. Rather than a separate support structure for the acoustic elements, in other embodiments, the system's frame structure serves as the support structure for mounting the acoustic elements.

In one embodiment, the lower end of each vertical acoustic element could be attached to the support structure and the support structure is in turn attached to the frame structure. In another embodiment, the upper end of each vertical acoustic element could be attached to the support structure and the support structure is in turn attached to the frame structure. In yet another embodiment, the upper and lower ends of each vertical acoustic element are attached to the support structure and the support structure is in turn attached to the frame structure.

Further, the lower end of each vertical acoustic element could also be attached directly to the base member in a manner that does not dampen the sound emitted from the vertical acoustic element. Also, the upper end of each vertical acoustic element can be attached directly to the top support member in a manner that does not dampen the sound emitted from the vertical acoustic element.

In yet another embodiment, the upper ends of some of the vertical acoustic elements are attached directly to the top support member in a manner that does not dampen the sound emitted from the vertical acoustic element while the lower ends of the remaining vertical acoustic elements are attached directly to the base member in a manner that does not dampen the sound emitted from the vertical acoustic element.

In one embodiment, one end of each horizontal acoustic element is attached to the horizontal acoustic unit support structure and the support structure is in turn attached to the frame structure. In another embodiment, the horizontal acoustic elements are attached to one or more of the one or more substantially vertical support members.

In one embodiment, each acoustic element has opposed nodal points located proximate the opposed ends of the acoustic element, and wherein each acoustic element is mounted to the frame structure at one or both of the opposed nodal points.

The base structure in the earthquake detection system may be weighted for increased stability.

In one embodiment, the pendulum striker comprises a solid metal object, but as noted herein, the striker can be comprised of the other materials noted herein. For example, the striker may comprise steel, iron, bronze, etc. that has sufficient mass and weight to cause the acoustic element to emit a sound when impacted by the striker.

Within an acoustic unit, the acoustic elements may be the same size, or different sizes, and may be different materials to create different sounds. Also, within each earthquake detection system, there may be employed one or more acoustic units of either the horizontal or vertical variety.

Additionally, rather than combining horizontal and vertical acoustic units within the same system, as described in connection with one embodiment herein, in yet another embodiment of the present invention, there is described a vertically-oriented earthquake detection system. The vertically-oriented earthquake detection system is similar to the combination system, in that it also employs one or more vertical acoustic units, but differs in that it does not employ any horizontal acoustic units.

Likewise in yet another embodiment of the present invention, there is described a horizontally-oriented earthquake detection system. The horizontally-oriented earthquake detection system is similar to the combination system, in that it also employs one or more horizontal acoustic units, but differs in that it does not employ any vertical acoustic units.

The horizontally-oriented earthquake detection system may be used by itself, or in combination with a vertically-oriented earthquake detection system and vice versa.

### BRIEF DESCRIPTION OF THE DRAWINGS

FIG. 1A is an elevation view of a combination vertically and horizontally oriented earthquake detection system according to one embodiment of the present disclosure.

FIG. 1B is an elevation view of a vertically oriented earthquake detection system according to another embodiment of the present disclosure.

FIG. 1C is an elevation view of a horizontally oriented earthquake detection system according to yet another embodiment of the present disclosure.

FIG. 2 is a longitudinal cross-sectional view of the combination vertically and horizontally oriented earthquake detection system taken along lines 2-2 of FIG. 1A.

FIG. 3 is a partial top perspective view of the combination vertically and horizontally oriented earthquake detection system of FIG. 1A illustrating the vertically oriented earthquake detection system.

FIG. 4 is a right side plan perspective view of the combination vertically and horizontally oriented earthquake detection system of FIG. 1A.

FIG. 5 is a left side plan perspective view of the combination vertically and horizontally oriented earthquake detection system of FIG. 1A.

FIG. 6 is a cross-sectional view of the vertically oriented earthquake detection system taken along lines 6-6 of FIG. 1B.

FIG. 7 is a cross-sectional view of the horizontally oriented earthquake detection system taken along lines 7-7 of FIG. 1C.

FIG. 8A is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8B is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8C is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8D is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8E is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8F is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8G is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8H is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8I is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8J is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8K is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8L is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8M is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 8N is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9A is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9B is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9C is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9D is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9E is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9F is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 9G is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 10A is a longitudinal cross-sectional view of a combination horizontally and vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 10B is a longitudinal cross-sectional view of a combination horizontally and vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 10C is a longitudinal cross-sectional view of a combination horizontally and vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 10D is a longitudinal cross-sectional view of a combination horizontally and vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 11A is a perspective view of a horizontally oriented earthquake detection system according to another embodiment of the present disclosure employing a triangular support structure with chimes mounted vertically from the base, and the pendulum being mounted or hanging from the apex. Acoustic member(s) have been removed to permit viewing the pendulum.

FIG. 11B is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 11C is a longitudinal cross-sectional view of an earthquake detection system according to another embodiment of the present disclosure employing a triangular (preferably equilateral triangular) support structure where the chimes are mounted radially about the midpoint of one of the sides of the triangle, and the pendulum is mounted from a base corner opposite such midpoint and extends along the median. The orientation of the cross-sectional view in this figure is similar to the orientation of the cross-sectional view in FIG. 2 to permit unobstructed viewing of the pendulum structure within the radially-spaced array of acoustic members.

FIG. 11D is a longitudinal cross-sectional view of an earthquake detection system according to another embodiment of the present disclosure employing a triangular (preferably equilateral triangular) support structure where the chimes are mounted radially about the midpoint of one of the sides of the triangle, and the pendulum is mounted from the same side at such midpoint and extends along the median. The orientation of the cross-sectional view in this figure is similar to the orientation of the cross-sectional view in FIG. 2 to permit unobstructed viewing of the pendulum structure within the radially-spaced array of acoustic members.

FIG. 12A is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 12B is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 12C is a longitudinal cross-sectional view of a vertically oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 12D is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 12E is a longitudinal cross-sectional view of a horizontally oriented earthquake detection system according to another embodiment of the present disclosure. The orientation of the cross-sectional view in this figure is similar to the orientation of the cross-sectional view in FIG. 2 to permit unobstructed viewing of the pendulum structure within the radially-spaced array of acoustic members.

FIG. 13A is a perspective view of a vertically oriented earthquake detection system according to another embodiment of the present disclosure.

FIG. 13B is a perspective view of a vertically oriented earthquake detection system according to another embodiment of the present disclosure.

FIG. 13C is a perspective view of a vertically oriented earthquake detection system according to another embodiment of the present disclosure.

FIG. 13D is a perspective view of a vertically oriented earthquake detection system according to another embodiment of the present disclosure.

FIG. 14A is a longitudinal cross-sectional view of a vertically oriented earthquake detection system according to another embodiment of the present disclosure employing a radially-spaced array of chimes suspended vertically between the top and bottom structure, where the pendulum hangs from the top. The orientation of the cross-sectional view in this figure is similar to the orientation of the cross-sectional view in FIG. 2 to permit unobstructed viewing of the pendulum structure within the radially-spaced array of acoustic members.

FIG. 14B is a longitudinal cross-sectional view of a vertically oriented earthquake detection system according to another embodiment of the present disclosure employing a radially-spaced array of chimes suspended vertically between the top and bottom structure, where the pendulum is mounted from the bottom. The orientation of the cross-sectional view in this figure is similar to the orientation of the cross-sectional view in FIG. 2 to permit unobstructed viewing of the pendulum structure within the radially-spaced array of acoustic members.

FIG. 14C is a perspective partial view of FIG. 14A.

FIG. 14D is a longitudinal cross-sectional view of a horizontally oriented earthquake detection system according to another embodiment of the present disclosure employing a radially-spaced array of chimes suspended horizontally between the sides of the structure, where the pendulum is also mounted horizontally from the side. The orientation of the cross-sectional view in this figure is similar to the orientation of the cross-sectional view in FIG. 2 to permit unobstructed viewing of the pendulum structure within the radially-spaced array of acoustic members.

FIG. 15A is a longitudinal cross-sectional view of a vertically oriented earthquake detection system according to another embodiment of the present disclosure employing a support structure of a generally trapezoidal outer shape. The orientation of the cross-sectional view in this figure is similar to the orientation of the cross-sectional view in FIG. 2 to permit unobstructed viewing of the pendulum structure within the radially-spaced array of acoustic members.

FIG. 15B is a longitudinal cross-sectional view of a vertically oriented earthquake detection system according to another embodiment of the present disclosure employing a support structure of a generally trapezoidal outer shape. The orientation of the cross-sectional view in this figure is similar to the orientation of the cross-sectional view in FIG. 2 to permit unobstructed viewing of the pendulum structure within the radially-spaced array of acoustic members.

FIG. 16A is a perspective view of a chime or acoustic member mounting mechanism for receiving chimes.

FIG. 16B is a top plan view of FIG. 16A.

FIG. 16C is a longitudinal cross-sectional view of a vertically oriented earthquake detection system according to another embodiment of the present disclosure employing the mounting mechanism of FIG. 16A. The orientation of the cross-sectional view in this figure is similar to the orientation of the cross-sectional view in FIG. 2 to permit unobstructed viewing of the pendulum structure within the radially-spaced array of acoustic members.

FIG. 17A is a cross-sectional view taken along line 17A-17A of FIG. 16A.

FIG. 17B is a cross-sectional view taken along line 17B-17B of FIG. 16A.

FIG. 18A is a perspective view showing, by way of illustration, an acoustic member tube or chime mounted directly into a structural wall.

FIG. 18B is a side view of FIG. 18A.

FIG. 19 is an elevation view of a vertically oriented earthquake detection system according to another embodiment of the present disclosure employing a support structure that supports the radially-spaced apart set of hollow tubes (chimes) at their respective upper and lower nodal points.

FIG. 19A is a cross-sectional view taken along lines 19A-19A of FIG. 19.

FIG. 20A shows a mounting mechanism where wires are run through the upper and lower nodal points of the acoustic member, here a chime (either hollow or solid) to mount the chime to a structure.

FIG. 20B illustrates a mechanism for mounting a chime at its nodal point from the interior of the chime, such as generally taught by Kile et al., U.S. Pat. No. 6,111,178.

FIG. 20C illustrates a mechanism for mounting a chime at its nodal point from the interior of the chime.

FIG. 21A illustrates a mechanism for mounting an acoustic member (e.g., solid bar) about its nodal point.

FIG. 21B illustrates another mechanism for mounting an acoustic member (e.g., solid bar) about its nodal point.

FIG. 22 shows an acoustic member, such as solid tube, hollow chime, or solid bar (shown here as a hollow tube), mounted in suspension (here, over an open channel) using wire around the nodal points of the acoustic member.

FIG. 22A is a cross-sectional view taken along lines 22A-22A of FIG. 22.

FIG. 22B is an enlarged view of section 22B of FIG. 22A.

FIG. 23 is an exploded view of FIG. 22.

FIG. 24A is a longitudinal cross-sectional view of a vertically oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 24B is a longitudinal cross-sectional view of a vertically oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 24C is a longitudinal cross-sectional view of a vertically oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 24D is a longitudinal cross-sectional view of a vertically oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 24E is a longitudinal cross-sectional view of a horizontally oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 24F is a longitudinal cross-sectional view of a horizontally oriented earthquake detection system according to another embodiment of the present disclosure where the acoustic members are mounted from at least one of their nodal points. The orientation of the cross-sectional view in this figure is similar to the orientation of the cross-sectional view in FIG. 2 to permit unobstructed viewing of the pendulum structure within the radially-spaced array of acoustic members.

FIG. 25 illustrates, in side view, an example for connecting an acoustic element (e.g., hollow or solid tube, solid bar, etc.), at its nodal points, to a structure.

FIG. 26 shows, in partial side view, an example for connecting a solid acoustic bar, at one of its nodal points, to a structure.

FIG. 27A is an elevation view of a vertically oriented earthquake detection system according to one embodiment of the present disclosure where each group of different-sized acoustic members are suspended from their upper and lower nodal points in radial fashion about a pendulum striker system.

FIG. 27B is a longitudinal cross-sectional view taken along lines 27B-27B of FIG. 27A.

### DETAILED DESCRIPTION OF THE INVENTION

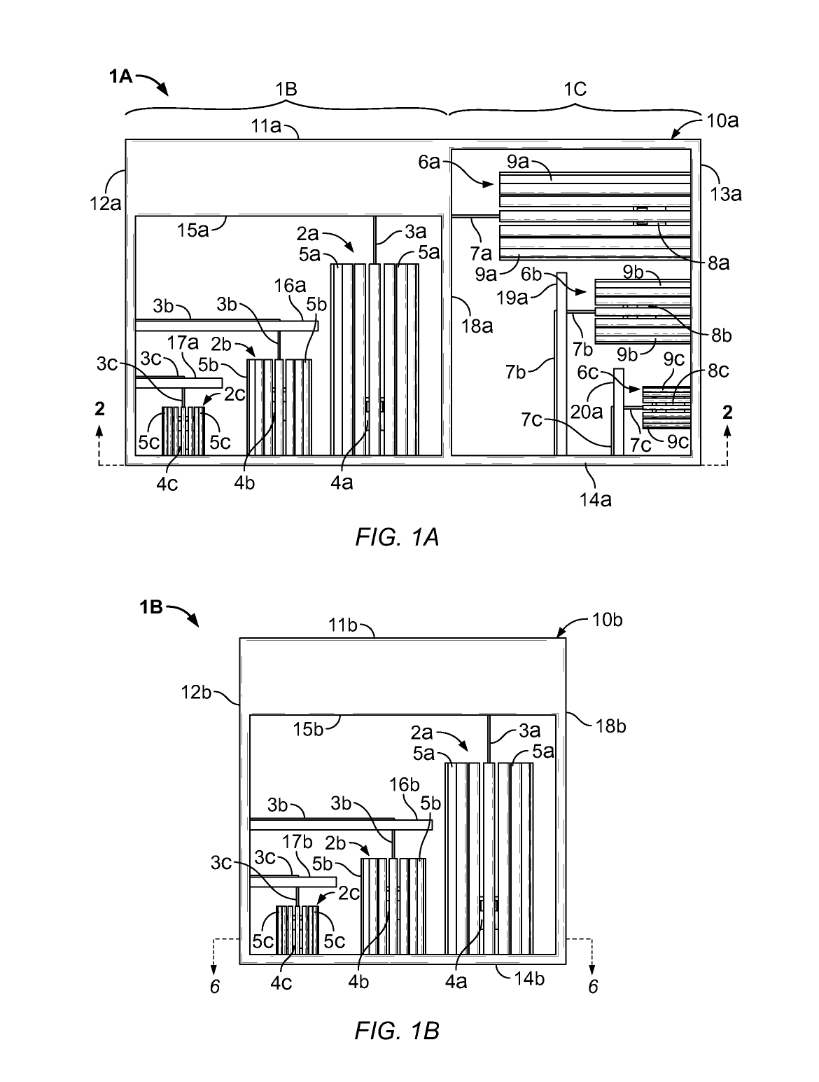

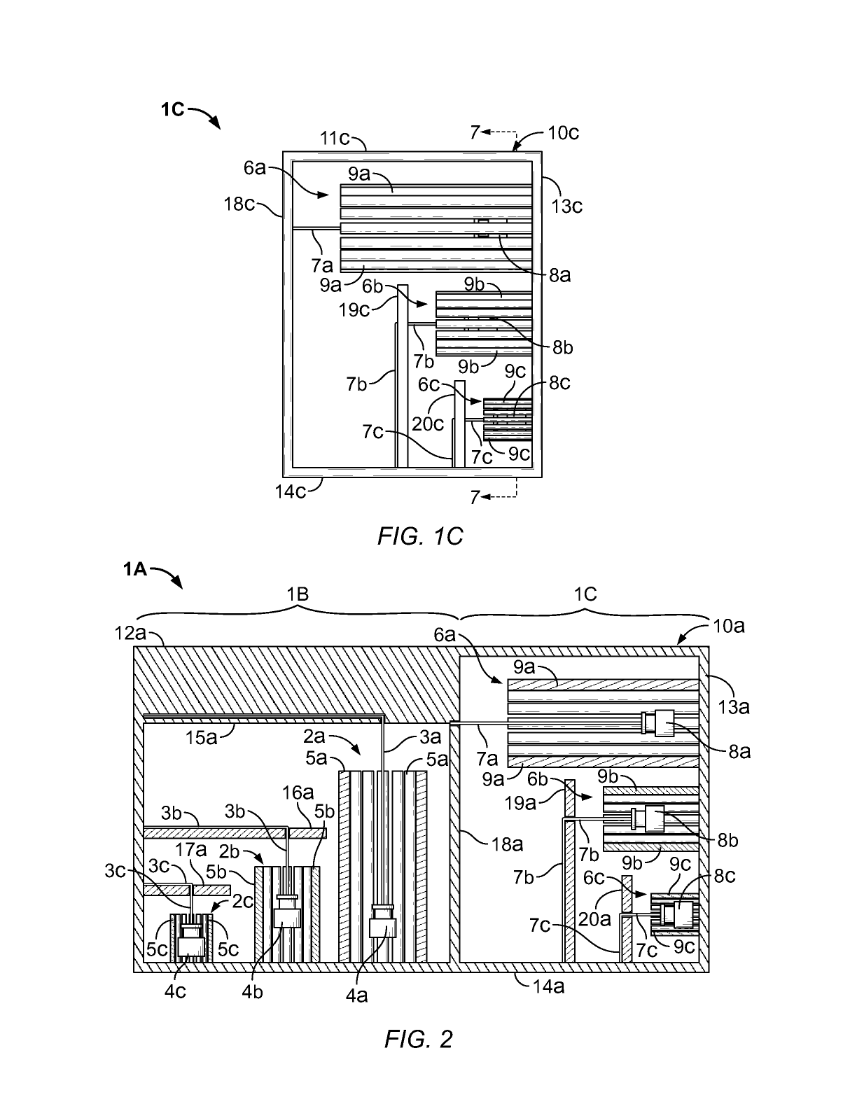

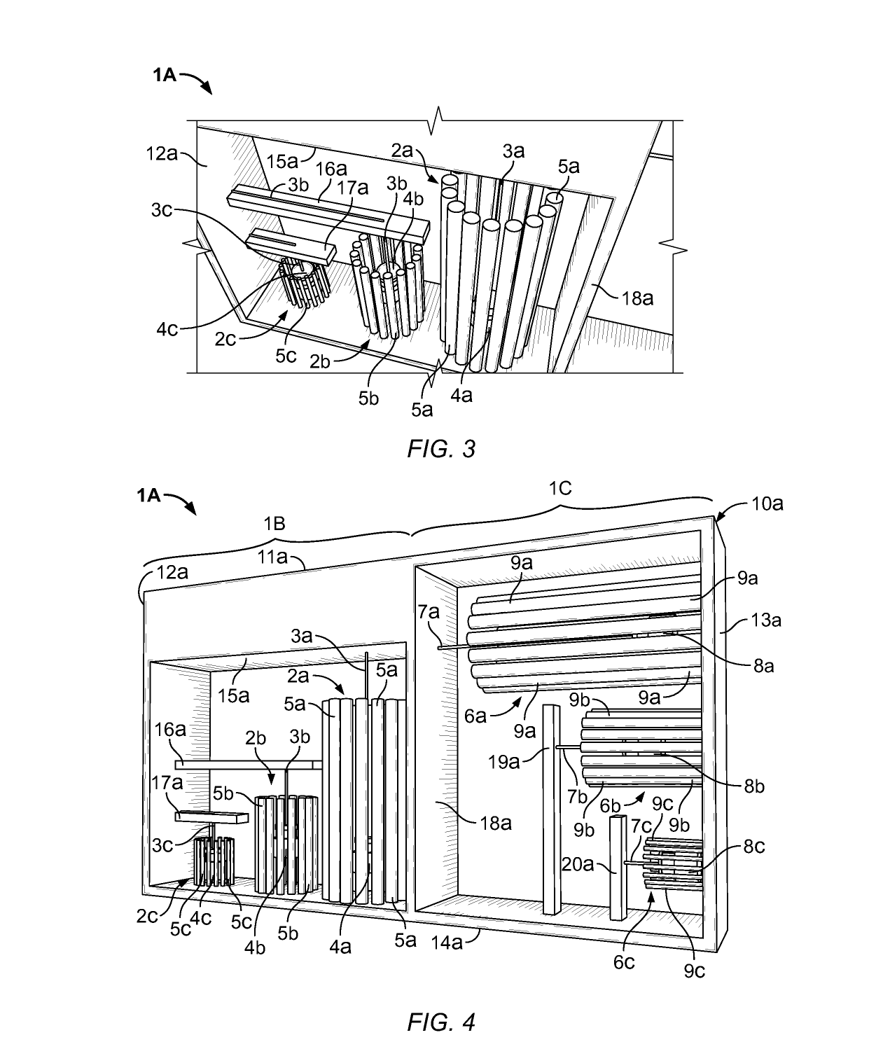

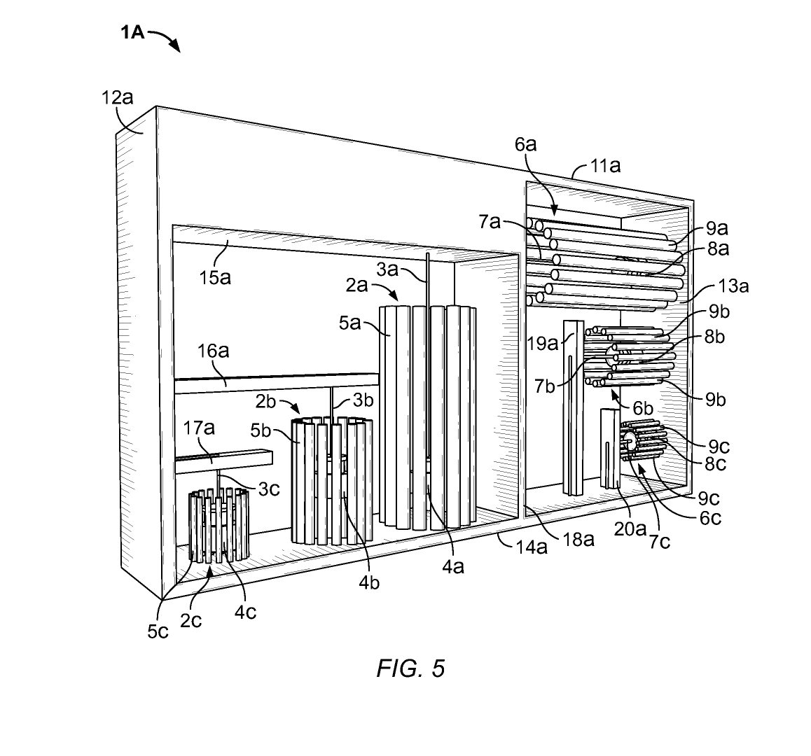

Referring to FIGS. 1A, 2, 3, 4, and 5 there is shown an exemplary combination vertically and horizontally oriented earthquake detection system 1A. This particular embodiment employs a combination of a vertically oriented earthquake detection system 1B and a horizontally oriented earthquake detection system 1C. The vertically oriented earthquake detection system 1B comprises one or more vertical acoustic units (2a, 2b, 2c) that may be of varying sizes, e.g., large, medium and small. The horizontally oriented earthquake detection system 1C comprises one or more horizontal acoustic units (6a, 6b, 6c) that may be of varying sizes. These acoustic units are mounted in a suitable housing 10a.

More specifically, each vertical acoustic unit (2a, 2b, 2c) comprises a plurality of acoustic elements (5a, 5b, 5c) arranged substantially vertically in radial fashion in spaced-apart relationship. The vertical acoustic units (2a, 3b, 2c) further comprise a pendulum striker (4a, 4b, 4c) attached to one end of a hanging wire, cord, rope, rod or the like (3a, 3b, 3c). The opposite end of each hanging wire, cord, rope or rod (3a, 3b, 3c) is attached to the housing or other support structure in a manner that orients the pendulum strikers (4a, 4b, 4c) at the centerpoint between the radially spaced-apart acoustic elements (5a, 5b, 5c). The point of attachment of the cord to the housing may be a pivot point. The length of the hanging wire can be adjusted to optimize the swing radius of the pendulum strikers to permit the strikers to strike the acoustic elements during an earthquake event to create an audible alarm. Likewise, the radial distance of the spaced-apart acoustic members, as well as the size (outer striking diameter) and weight of the pendulum strikers can be varied to optimize the interplay between the striker and the acoustic members. In one embodiment, the vertical acoustic unit comprises a plurality of acoustic elements arranged substantially vertically in radial, spaced-apart relationship, but the vertical acoustic unit may also comprise a unique bell, chime or cylinder, or any object with acoustic properties to emit the desired sounds upon impact by a striker.

Each horizontal acoustic unit (6a, 6b, 6c) comprises a plurality of acoustic elements (9a, 9b, 9c) arranged substantially horizontally in radial fashion in spaced-apart relationship. The horizontal acoustic units (6a, 6b, 6c) further comprise a pendulum striker (8a, 8b, 8c) attached to one end of a pendulum attachment member (7a, 7b, 7c). The opposite end of the pendulum attachment member (7a, 7b, 7c) is attached to the housing in a manner that orients the pendulum strikers (8a, 8b, 8c) at the centerpoint between the radially spaced-apart acoustic elements (9a, 9b, 9c). The length of the pendulum attachment member (7a, 7b, 7c) can be adjusted to optimize the swing or oscillation radius of the pendulum strikers to permit the strikers to strike the acoustic elements during an earthquake event to create an audible alarm. For example, it is preferable that the striker be mounted so that it can impact the center area or sweet spot along the length of the acoustic element. Likewise, the radial distance of the spaced-apart acoustic members, as well as the size (outer striking diameter) and weight of the pendulum strikers can be varied to optimize the interplay between the striker and the acoustic members. The pendulum attachment member (7a, 7b, 7c) is a rigid, but flexible rod (for example of metal or plastic composition or the like, including wood, polymers, composites, and combinations thereof) capable of maintaining the striker (8a, 8b, 8c) at the radial centerpoint between the acoustic elements in the absence of an earthquake, but also permitting the strikers to strike the acoustic elements (9a, 9b, 9c) during an earthquake event to create an audible alarm. In one embodiment, the horizontal acoustic unit comprises a plurality of acoustic elements arranged substantially horizontally in radial, spaced-apart relationship, but the horizontal acoustic unit may also comprise a unique bell, chime or cylinder, or any object with acoustic properties to emit the desired sounds upon impact by a striker.

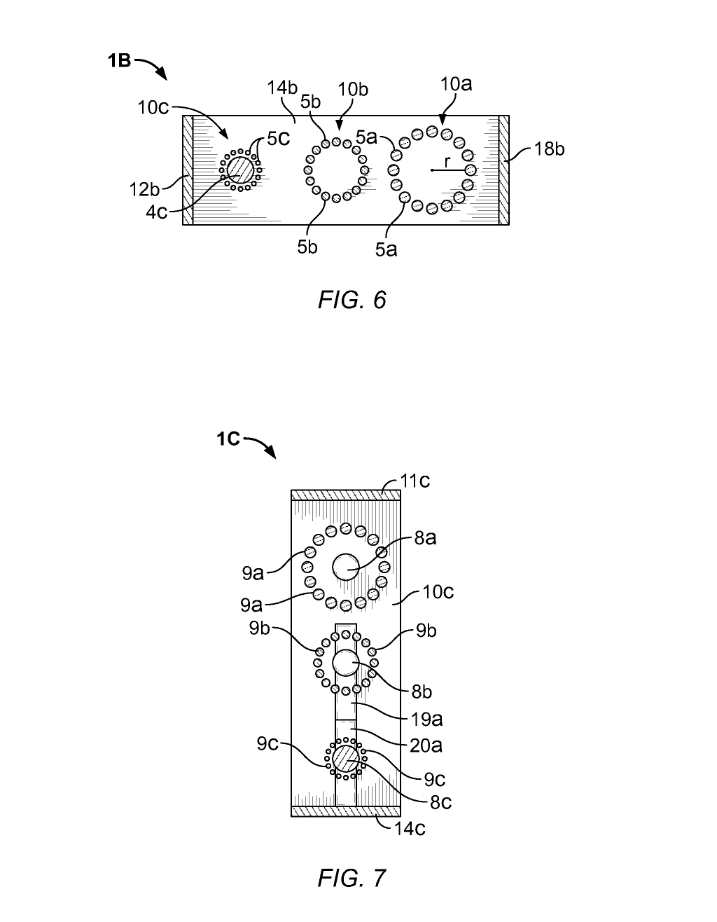

The plurality of horizontal and vertical acoustic elements are generally spaced apart about a circle of radius (r), for example, as shown in FIGS. 6 and 7.

The pendulum strikers (4a, 4b, 4c, 9a, 9b, 9c) are preferably formed of a solid material, for example, steel, iron, bronze, etc. that has sufficient mass and weight to cause the acoustic element to emit a sound when impacted by a striker.

In the embodiment shown in FIGS. 1A, 2, 4 and 5, the housing or frame 10a generally comprises a housing or frame top structural member 11a (shown here, e.g., to be substantially vertical); opposed housing or frame outer side structural members 12a, 13a (shown here, e.g., to be substantially vertical; and a housing or frame structural base member 14a. The base member 14a is preferably constructed of a heavy material, such as iron, or alternately, is weighted with weights or other weighting material (not shown) to provide stability to the structure during an earthquake so that the system 1A does not fall during the earthquake. The top 11a and opposed side structural members 12a, 13a are preferably of a more lightweight material, such as, for example, plastic.

The housing 10a (FIGS. 1A, 2, 4 and 5) also comprises one or more structural support members for mounting the pendulum devices to the housing. For example, support member 15a (which can be the same as top member 11a) can be employed for mounting the pendulum wire 3a to permit pendulum striker 4a to be maintained at the radial center between the spaced-apart acoustic elements 5a in acoustic unit 2a. Similarly, support member 16a can be employed for mounting the pendulum wire 3b to permit pendulum striker 4b to be maintained at the radial center between the spaced-apart acoustic elements 5b in acoustic unit 2b. Also, support member 17a can be employed for mounting the pendulum wire 3c to permit pendulum striker 4c to be maintained at the radial center between the spaced-apart acoustic elements 5c in acoustic unit 2c. Additionally, structural support member 18a can be employed for mounting pendulum attachment member 7a to permit pendulum striker 8a to be maintained at the radial center between the spaced-apart acoustic elements 9a in acoustic unit 6a. Similarly, structural support member 19a can be employed for mounting pendulum attachment member 7b to permit pendulum striker 8b to be maintained at the radial center between the spaced-apart acoustic elements 9b in acoustic unit 6b. Also, structural support member 20a can be employed for mounting pendulum attachment member 7c to permit pendulum striker 8c to be maintained at the radial center between the spaced-apart acoustic elements 9c in acoustic unit 6c.

The acoustic elements (5a, 5b, 5c, 9a, 9b, 9c) may comprise any material capable of emitting a sound when struck by a striker (4a, 4b, 4c, 8a, 8b, 8c). For example, solid metal or wood bars or rods and hollow metal or wood tubes could be employed much like those used on musical instruments such as, e.g., xylophones, marimbas, vibraphone, tubular chimes, wind chimes, and the like. Preferably, the wood used for the acoustic elements is a hardwood, such as, for example, Honduran Rosewood, Cardinal wood, Purpleheart wood, African Padouk, Oak, Durian, Meranti and the like. Synthetic materials, such as “KELON”, a synthetic thermoplastic polymeric material (Lati Industria Termoplastica SPA, Italy) blended with extruded glass fibers or ceramic materials, or other synthetic materials may also be used. KELON® xylophone and marimba bars are available from Selmer Company, Inc. (Elkhart, Ind.). Metal bars, rods and tubes used as acoustic elements could be made from metal alloys, steel, copper, aluminum, high-copper alloy called duraluminum and the like. Any material that is acoustically responsive when struck by a striker can be employed; however, materials providing the loudest acoustic response are preferred.

As is known and understood in the art, the acoustic elements (5a, 5b, 5c, 9a, 9b, 9c) should preferably be mounted to the housing 10a or other structural members in a fashion that minimizes any damping of the sound. For example, each bar, rod or tube will have a desired overall length, and along such length will be located a set of opposed nodal points that are located inward from each end of the bar, rod or tube at a point approximately 22% of the length of the bar, rod or tube. Nodal points are areas with an amplitude of vibration equal to zero. These areas of no vibration, or nodes, are, for example, precisely where the supports for a glockenspiel musical instrument are placed, or where supports for chimes are located. In the present invention, preferably, each chime, bar or rod (acoustic element) is mounted to the housing 10a using a mounting assembly that attaches to one or both of the nodal points of the chime, bar or rod acoustic element to thereby secure the acoustic element in place without damping the sound produced when a striker strikes the surface of the acoustic element.

One exemplary chime mounting system is disclosed and described in U.S. Pat. No. 6,111,117 (Kile et al.) issued to Grace Note Chimes, Inc. (Mariposa, Calif.) (www.gracenotes.com), and is incorporated herein by reference in its entirety for all purposes. The Kile et al. patent describes the use of a pinned suspension device that attaches to the interior surface of the chime at the opposed nodal points. More particularly, Kile et al. discloses chime assembly that includes a plurality of tubular chimes arranged in a straight or curved line. The chime assembly includes a support frame having upper and lower damping couplings. Each chime is mounted to a support rod passing coaxially through the chime through the engagement of spring elements engaging holes formed at the nodal points of the chime. The ends of the support rod are supported by the upper and lower damping couplings. The damping couplings include grommets circumscribing the support rod and damping foam surrounding the ends of the support rod.

For example, a vertical or horizontal acoustic unit of the present invention (such as illustrated in FIGS. 1A, 2, 4 and 5) could be constructed where each acoustic element (here, e.g., a tubular chime) is mounted to a support rod passing coaxially through the chime through the engagement of spring elements engaging holes formed at the nodal points of the chime. The chimes could be arranged in a circular, spaced apart relationship and fixed in place by mounting the ends of the support rod between opposed structural members. A pendulum striker could then be mounted from the support structure (appropriately for vertical or horizontal acoustic unit configuration) to provide a striker capable of striking the radially interior surfaces of the tubular chimes.

Resonant chime tubes held at their nodal points are typically struck on their exterior to emit sound. The usual manner of supporting such tubes in vertical position is to provide a hanger cord secured at its upper end to a fixed member and extending vertically down to some form of connection at its lower end with the tube. They may also be held in a horizontal position with the cord stretched horizontally between fixed points. The connection between the hanger cord and the chime tube has taken many forms in the prior art. Cylindrical plug elements have been forced into the ends of cylindrical chime tubes for connection to hanger cords. U.S. Pat. No. 1,813,171 (Klein) (which is incorporated herein by reference in its entirety for all purposes), for example, discloses one form of such a plug element force-fitted into the upper end of a chime tube.

Other mechanisms for connecting hanger cords to chime tubes include holes or indentations formed in the chime tube wall, one form of which is disclosed in U.S. Pat. No. 2,820,431 (Lescher) (which is incorporated herein by reference in its entirety for all purposes). Variations include the drilling of holes through opposite sides of the chime tube at its nodal point and insertion of the hanger cord through the holes so that two runs of the cord extend upwardly on the outside of the chime tube to the point of suspension. It is also known to insert an expansion spring of small diameter through the opposed holes in the chime tube with the hanger cord secured to the mid-point of the spring. Also of interest in the prior art are chime tube configurations which include stiffening elements having equally circumferentially spaced legs inserted within the chime tube at suitable levels for stiffening or solidifying the tubes. One form of this design is disclosed in U.S. Pat. No. 485,542 (Harrington) (which is incorporated herein by reference in its entirety for all purposes). They function to control the pitch of emitted sound and not for attachment of hanger cords.

Another example support structure for a tubular chime is disclosed in U.S. Pat. No. 6,167,832 issued to Vooris, which is incorporated herein by reference in its entirety for all purposes. Vooris generally describes a chime tube supported by a coaxial hanger cord comprising a resilient clip element connecting the cord and the interior of the chime tube having two or more legs which have a straight line length longer than the inside radius of the chime tube before insertion and which bend to grip the inside of the chime tube upon insertion and hold the clip element at the desired position.

For example, where the acoustic element is a bar, the bar may be attached to a support structure much like a xylophone bar is attached to the xylophone frame, namely, by drilling a countersunk hole at the center width of the bar (at one nodal point), and then securing the bar to the support structure using a screw, where the bar is supported underneath by a felt pad proximate the hole to support the bar off of the surface of the support structure without damping the sound of the bar. The bar could be attached to the support member in like fashion using screws at each end of the bar through each respective nodal point. A rubber grommet could also be used to shield the screw from contacting the bar (acoustic member).

These exemplary attachment mechanisms, known in the art, could be employed to mount embodiments of the acoustic elements of the present invention to the support structure or directly to the frame/housing.

Although the earthquake system depicted in FIGS. 1A, 2, 4 and 5 illustrates the use of three, different-sized horizontally oriented acoustic units in combination with the use of three, different-sized vertically oriented acoustic units, the present invention could also comprise an earthquake detection system comprising only vertically oriented acoustic units, such as illustrated in FIGS. 1B and 6, or an earthquake detection system comprising only horizontally oriented acoustic units, such as illustrated in FIGS. 1C and 7. Furthermore, although the earthquake system depicted in FIGS. 1A, 2, 4 and 5 illustrates the use of three, different-sized horizontally oriented acoustic units in combination with the use of three, different-sized vertically oriented acoustic units, the system could employ acoustic units that are all of the same size. Also, in one embodiment, the earthquake detection system could employ a single acoustic unit (either vertically- or horizontally-oriented) of a desired size. As will be understood by one of ordinary skill in the art having the benefit of the present disclosure, any combination of vertical acoustic units (of equal or varying size), any combination of horizontal acoustic units (of equal or varying size) and any combination of horizontal and vertical acoustic units (of any size) could be employed.

Additionally, the acoustic units of the present disclosure could also be modified to include resonator, timber box or similar structural elements (not shown) located proximate to the acoustic elements to amplify the sound, for example, via use of a structure to hold a column of air designed to be of the correct size to resonate when sound waves from the acoustic element (bars, chimes, rods, etc.) enter it. For example, PVC pipe or aluminum tubing could be used to create lightweight resonator(s). Additionally, as is known in the art, if tubular chimes are employed, the tubular chimes could be constructed to be self-resonating chimes where the column of air inside each chime is tuned to resonate at the same pitch as the chime itself thereby enhancing the sound emitted from the tubular chime.

With the vertical acoustic elements, the vertical pendulum is hanging from the center of the acoustic element so that the pendulum striker is within the circular array of vertical acoustic elements. In the absence of an earthquake, the pendulum remains at its equilibrium position. When an oscillatory earthquake occurs, the frame and the acoustic element move with the earthquake movement impacting against the initially stationary pendulum, making noise by provoking the vibration of the acoustic elements. In other words, when an oscillatory earthquake begins, the weight of the pendulum striker will tend to maintain the striker in place while the earthquake detection device structure moves based on the movement of the earthquake causing, in this type of earthquake, the device to move in a back and forth in a horizontal pattern relative to the pendulum striker.

With the horizontal acoustic elements, the horizontal pendulum is supported via a rigid but very flexible stick or rod. The pendulum striker, mounted on the end of this flexible rod, is therefore positioned within the circular array of horizontal acoustic elements. In the absence of an earthquake, the pendulum remains at its equilibrium position. When a trepidatory earthquake occurs, the frame and the acoustic element move up and down, impacting against the pendulum striker, making noise by provoking the vibration of the acoustic elements. The device moves up and down in a vertical pattern relative to the pendulum striker and/or visa versa causing impact between the striker and the acoustic element(s).

In a preferred embodiment of the present invention, a combination of both vertical and horizontal acoustic elements is employed to achieve the best effect of the alarm with both, oscillatory and trepidatory earth movements. The vertical acoustic elements will work during an oscillatory earthquake, and the horizontal acoustic elements will work during a trepidatory earthquake

In another preferred embodiment of the present invention, the earthquake detection system employs pendulums and acoustic elements of different sizes capable of responding to different earthquake intensities. Earthquakes are classified according its intensity in scales of Seismic momentum magnitude “Mw”, usually understood as “grades”. For example, earthquakes of medium intensity would be those of Mw=7.0, Mw=7.1, Mw=7.2, etc. Earthquakes of great intensity would be those of Mw=8.0, Mw=8.1, Mw=8.2, etc. Mega or super earthquakes would be those of Mw=9.0, Mw=9.1, Mw=9.2, etc. Based on pendulum and other physics laws, the dimensions of the acoustic elements (diameter, thickness, etc.); pendulums weights, etc.; length of wires/cords or rods supporting pendulums, etc., may be calculated and designed scientifically in a way that, for example: during a Mw=7.0 earthquake the small acoustic element makes a sound; during a Mw=8.0 earthquake the small and medium size acoustic elements make a sound; and during a Mw=9.0 earthquake the small, medium and large size acoustic elements make a sound.

As will be understood by those having the benefit of the present disclosure, there are many variations of the configurations employed for the earthquake detection system of the present invention. These systems can employ one or more vertical acoustic units (of similar or different sizes), one or more horizontal acoustic units (of similar or different sizes), and/or one or more angular acoustic units (as described below) (of similar or different sizes) and/or combinations thereof. These systems can be permanently installed, be movable (like a piece of furniture), or be portable to permit use when travelling to other locations.

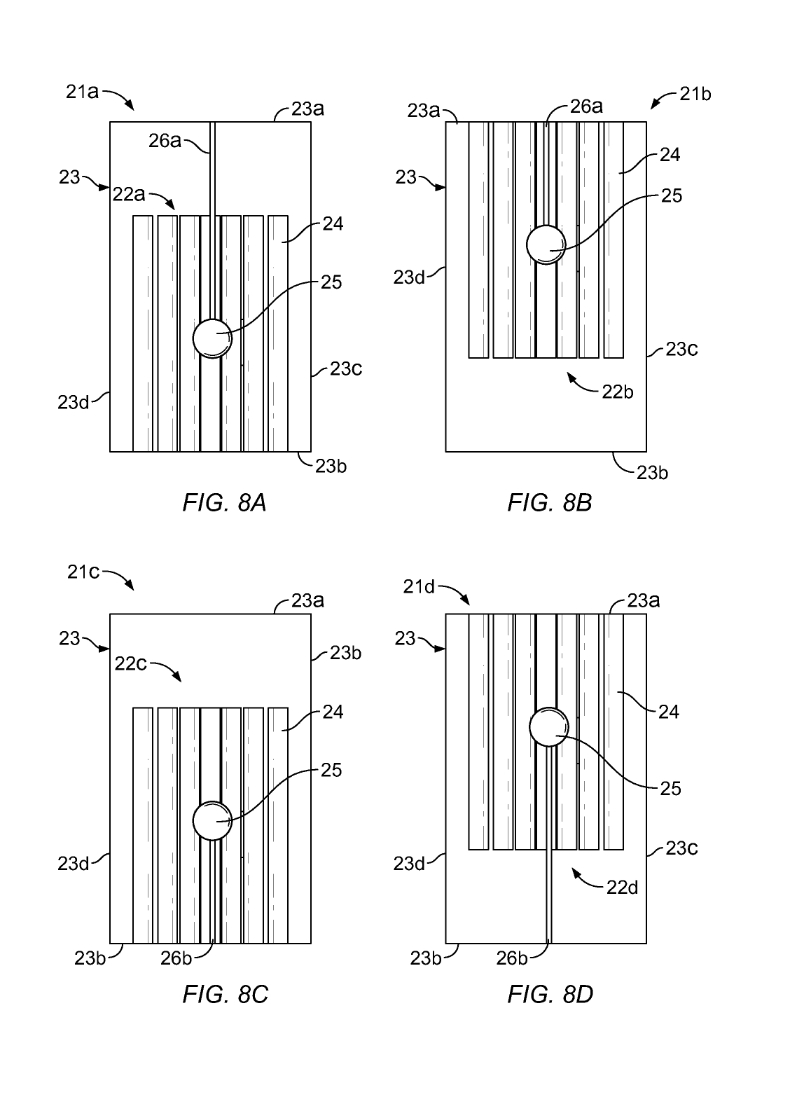

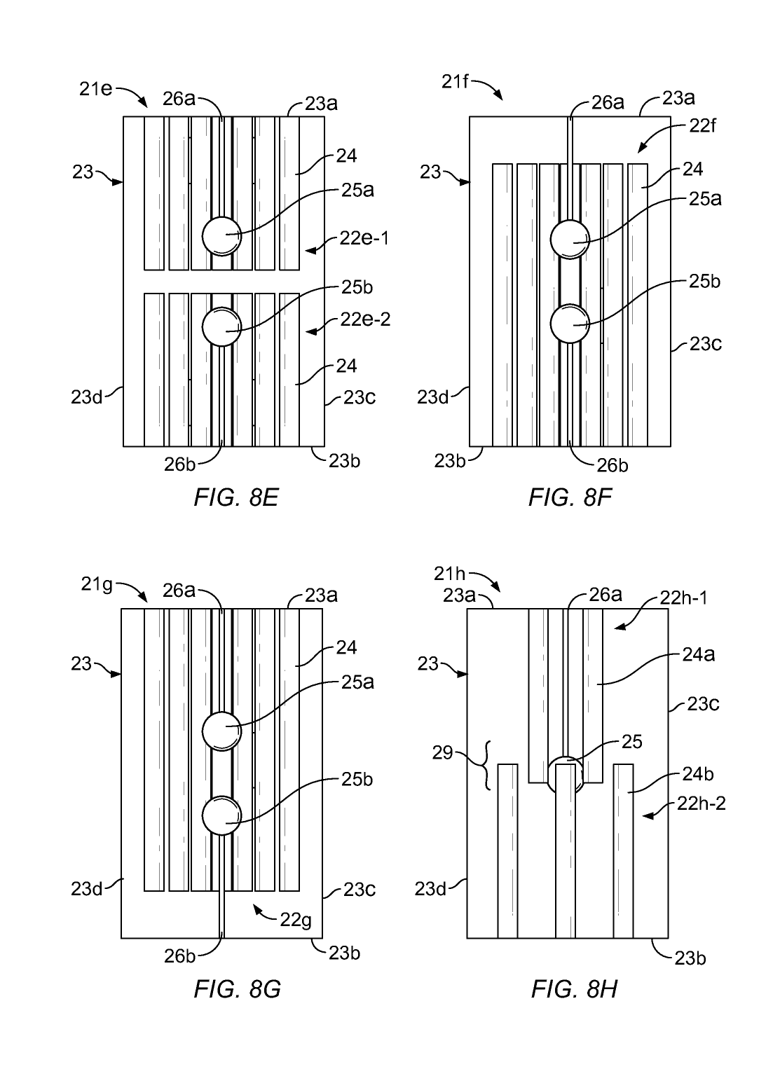

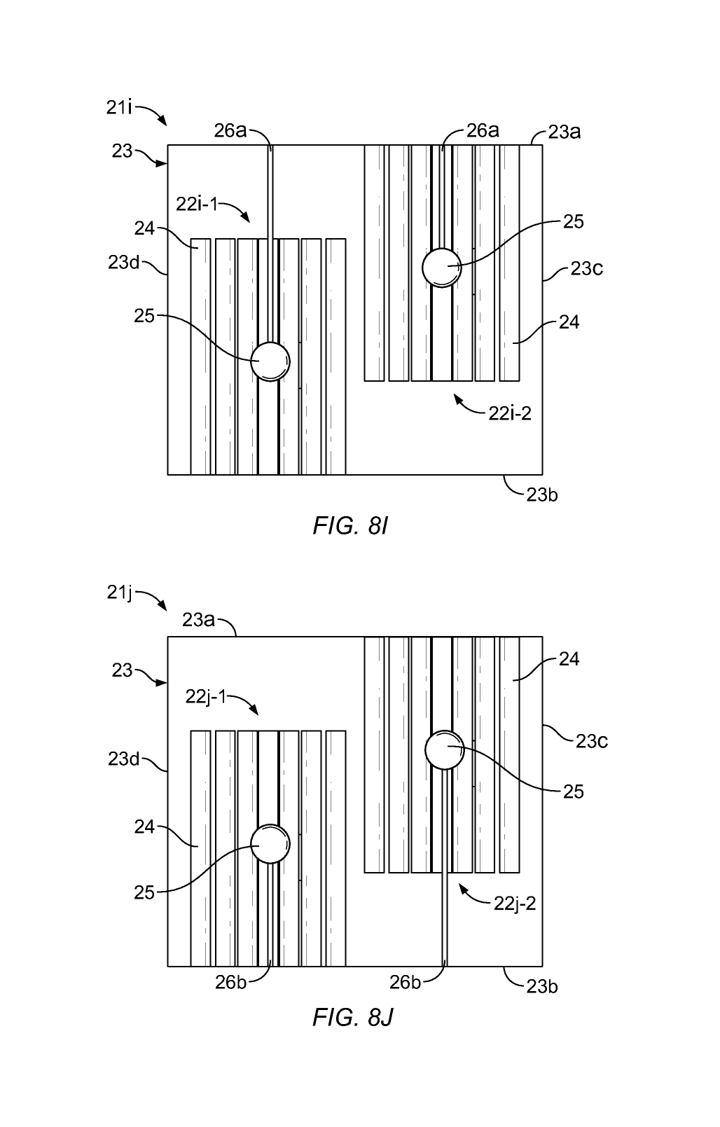

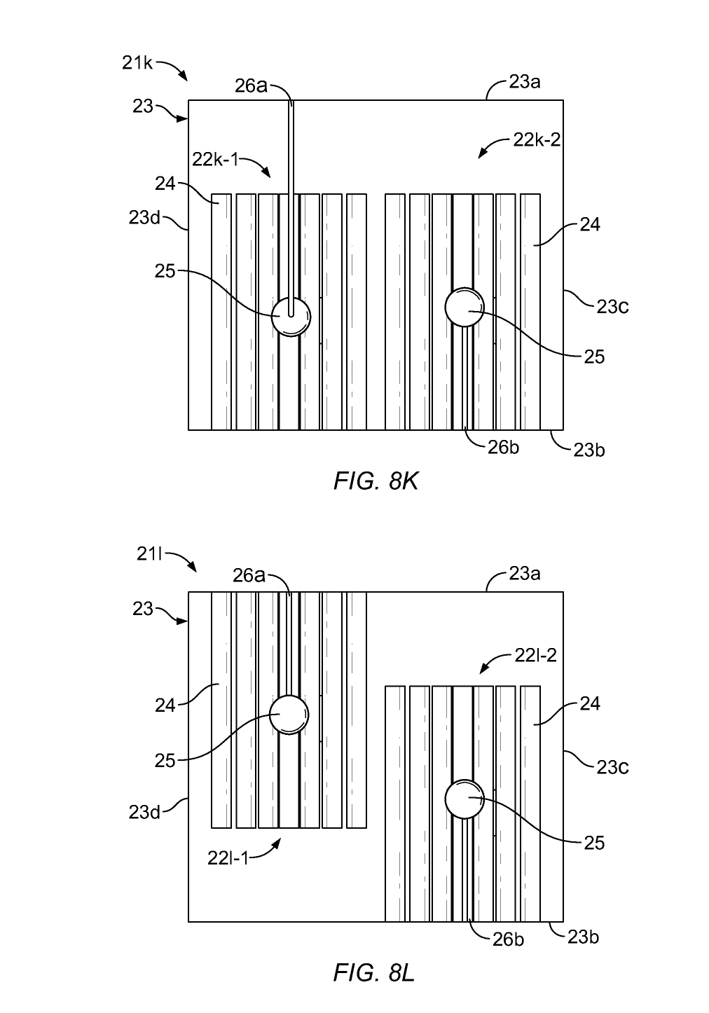

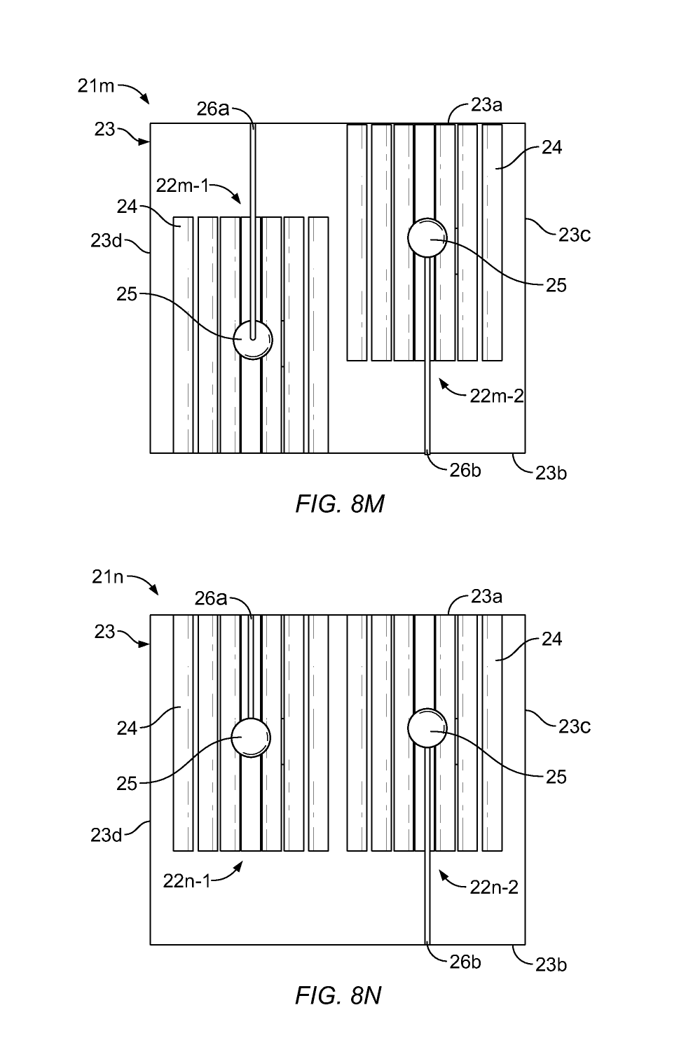

For example, referring now to FIGS. 8A-8N there are depicted a variety of vertically oriented earthquake detection systems 21a-21n, respectively, according to other embodiments of the present disclosure. In these embodiments, one or two vertical acoustic units 22a-22n are employed as illustrated (although any number of acoustic units could be employed), shown here installed within a housing 23 (generally comprising a top wall or ceiling 23a, a base 23b, and opposed side support walls or structures 23c, 23d). Each vertical acoustic unit (22a-22n) comprises a plurality of acoustic elements or members (24) arranged substantially vertically in radial fashion in spaced-apart relationship about a centerpoint. Each acoustic unit (22a-22n) employs a pendulum striker 25 (which may be of varying size, shape and weight) attached to one end of a hanging wire, cord, rope, rod or the like (26a), or attached to one end of a rod or the like (26b). The opposite end of each hanging wire, cord, rope or rod (26a) is attached to the housing top member (23a) or other support structure in a manner that orients the pendulum strikers (25) at the centerpoint between the radially spaced-apart acoustic elements (24). In other embodiments, opposite end of each hanging wire, cord, rope or rod (26b) is attached to the housing base member (23b) or other support structure in a manner that orients the pendulum strikers (25) at the centerpoint between the radially spaced-apart acoustic elements (24). The point of attachment of the wire, cord, rope or rod to the housing may be a pivot point.

More particularly, FIG. 8A shows an embodiment where the acoustic members (24) are mounted to the base (23b) and the pendulum hanging wire, cord, rope, rod or the like (26a) is attached to the top wall or ceiling (23a). FIG. 8A shows a vertical acoustic unit similar to those described in connection with FIGS. 1A-1B and 2. The embodiment of FIG. 8B is similar to that of FIG. 8A except that the acoustic members (24) are mounted from the top wall or ceiling (23a).

The embodiment of FIG. 8C is similar to that of FIG. 8A except that the opposite end of the rod (26b) is attached to the housing base member (23b). The rod or pendulum attachment member (26b) of FIG. 8C (or when a rod is employed as element 26a) is a rigid, but flexible rod (for example of metal or plastic composition or the like, including wood, polymers, composites, and combinations thereof) capable of maintaining the striker (25) at the radial centerpoint between the acoustic elements (24) in the absence of an earthquake, but also permitting the striker (25) to strike the acoustic elements (24) during an earthquake event to create an audible alarm. The embodiment shown in FIG. 8D is similar to that of FIG. 8C except that the acoustic members are mounted from the top structure (23a). It will be understood that the support structures 23a, 23b and 23d are not necessary for the embodiment of FIG. 8C.

FIG. 8E illustrates a vertical acoustic unit (21e) employing the acoustic units of FIGS. 8B and 8C, shown here in axial alignment with each other (22e-1, 22e-2). The embodiment of FIG. 8F is similar to that of FIGS. 8A and 8C in that it employs two pendulum strikers (25a, 25b) where one striker (25a) is attached to a pendulum attachment device (26a) attached to the ceiling member (23a) and the other striker (25b) is attached to a pendulum attachment device (26b) attached to the base (23b). The embodiment of FIG. 8G essentially combines the features of FIGS. 8B and 8D, and is similar to that of FIG. 8F except that the acoustic members are mounted from the ceiling (23a).

FIG. 8H depicts an embodiment much like a combination of those shown in FIGS. 8A and 8B where the upper vertical acoustic members (24a) (comprising part of unit 22h-1) are mounted from the ceiling (23a) in radially spaced apart relationship about the centerpoint, and the lower vertical acoustic members (24b) comprising part of unit 22h-2) are mounted from the base in radially spaced apart relationship about the centerpoint. The lengths of, and the total number of, upper and lower vertical acoustic members (24a, 24b) together forms a radially spaced apart array of acoustical members in a strike zone (29) where the striker (25) can impact the acoustic members (24a, 24b).

The embodiment of FIG. 8I is similar to that in FIG. 8E except that the acoustic units (22i-1, 22i-2) are not axially aligned, and both of the pendulum striker attachment members (26a) are mounted to the ceiling (23a). The embodiment of FIG. 8J is similar to that in FIG. 8E except that the acoustic units (22j-1, 22j-2) are not axially aligned, and both of the pendulum striker attachment members (26b) are mounted to the base (23b). The embodiment of FIG. 8K illustrates the use of two vertical acoustic units (22k-1, 22k-2) in what is essentially a combination of the embodiments in FIGS. 8A and 8C. The embodiment of FIG. 8L is similar to that in FIG. 8E except that the acoustic units (22l-1, 22l-2) are not axially aligned. The embodiment of FIG. 8M illustrates the use of two vertical acoustic units (22m-1, 22m-2) in what is essentially a combination of the embodiments in FIGS. 8A and 8D. The embodiment of FIG. 8N illustrates the use of two vertical acoustic units (22n-1, 22n-2) in what is essentially a combination of the embodiments in FIGS. 8B and 8D.

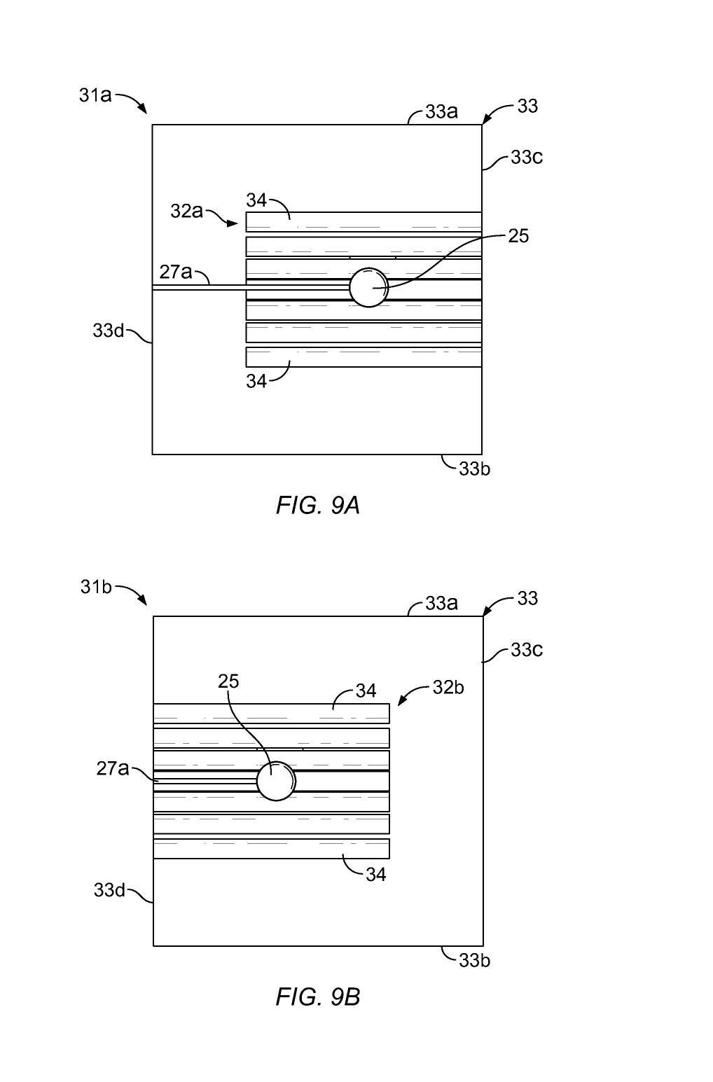

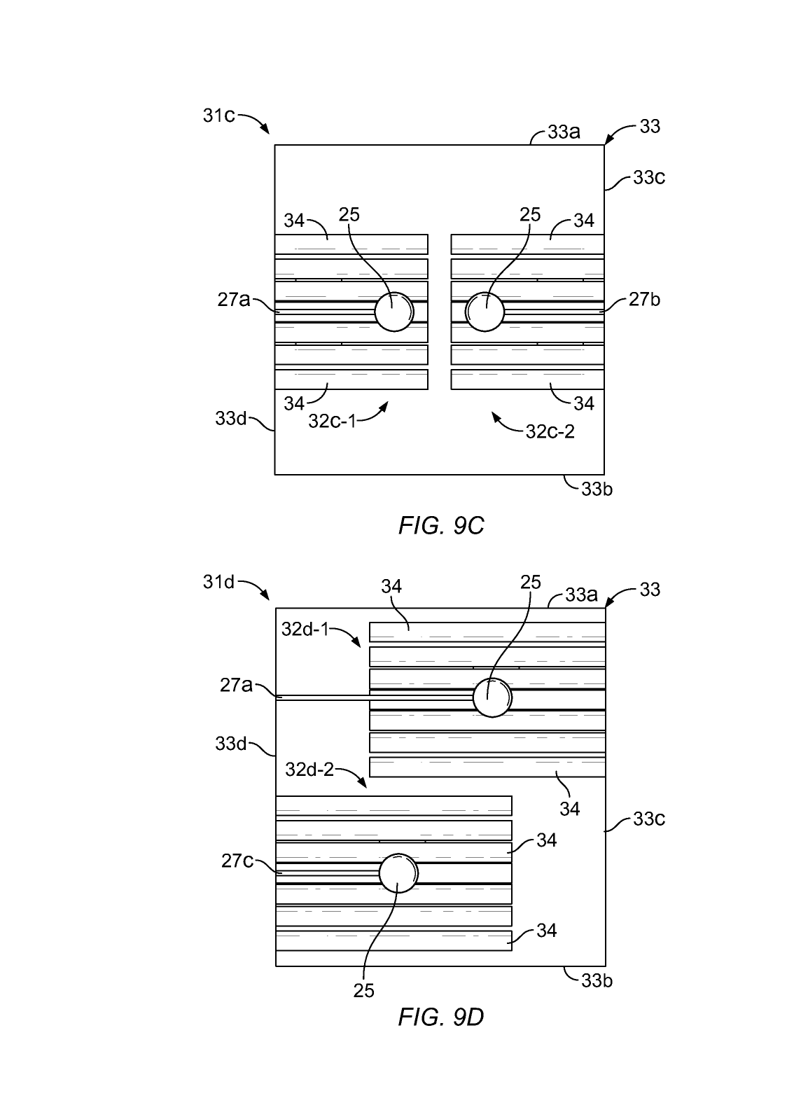

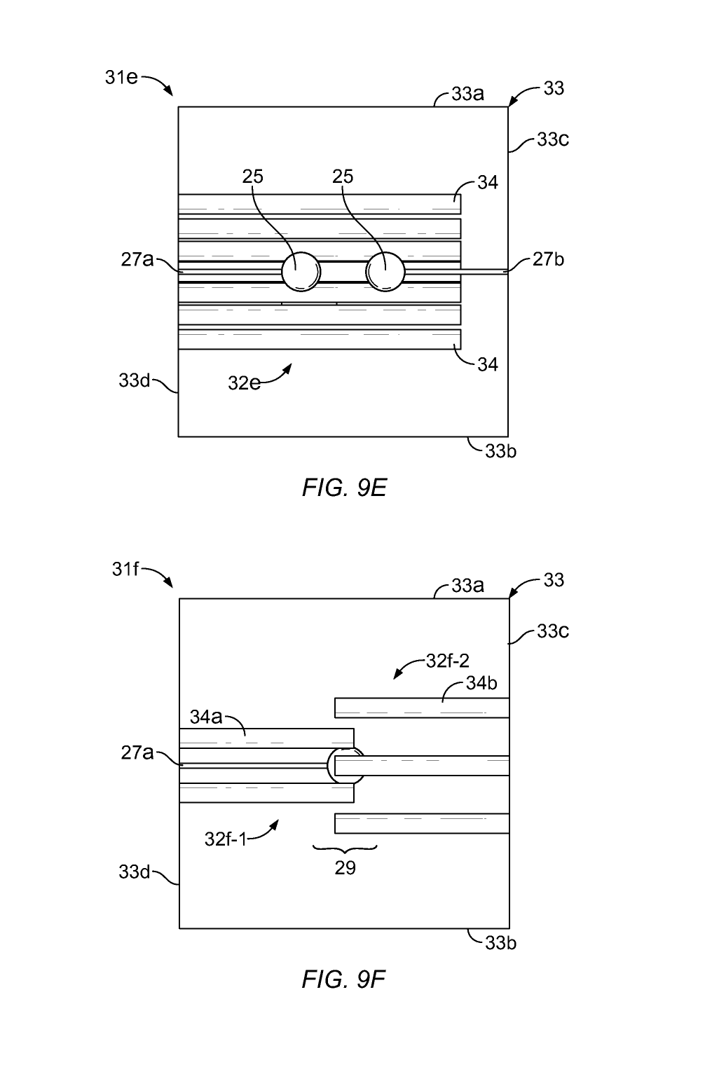

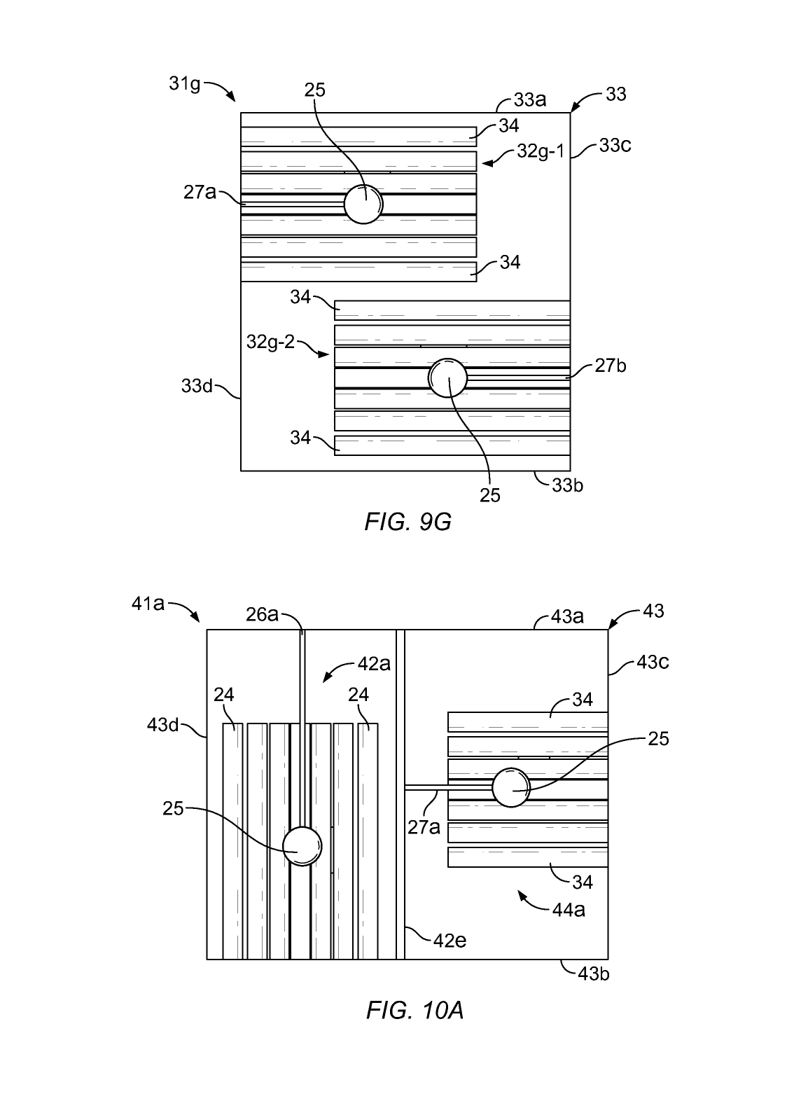

As will be appreciated from review of the embodiments of FIGS. 8A-8N, numerous of the systems depicted therein are essentially the same embodiment except rotated 180 degrees. For example, in the embodiment shown in FIG. 8A, if a rod is used as the striker attachment member 26a, then such embodiment could be rotated 180 degrees to serve as the embodiment shown in FIG. 8D, and thereby provide the option to use the unit in either vertical orientation (or as will be discussed below, in the horizontal orientation depicted in FIG. 9A) thereby increasing the versatility of end use for a single embodiment design. For example, an end user could obtain three of such embodiments and orient each one differently as an earthquake alarm system. Likewise, the same can be said of the embodiments in FIGS. 8B and 8C (and 9B discussed below); FIGS. 8E and 9C (discussed below); FIGS. 8F, 8G and 9E (discussed below); FIGS. 8H and 9F (discussed below); FIGS. 8I, 8J and 9D (discussed below); FIGS. 8K, 8N and rotated 90 degrees (not shown); FIGS. 8L and 9G (discussed below); FIG. 8M rotated 90 degrees (not shown); where such embodiments use a rod as the striker attachment member to permit such embodiments to be used in either vertical orientation or in a horizontal orientation.

Referring now to FIGS. 9A-9G there are depicted a variety of horizontally oriented earthquake detection systems 31a-31g, respectively, according to other embodiments of the present disclosure. In these embodiments, one or two horizontal acoustic units 32a-32g are employed as illustrated (although any number of acoustic units could be employed), shown here installed within a housing 33 (generally comprising a top wall or ceiling 33a, a base 33b, and opposed side support walls or structures 33c, 33d). Each vertical acoustic unit (32a-32g) comprises a plurality of acoustic elements or members (34, 34a, 34b) arranged substantially horizontally in radial fashion in spaced-apart relationship about a centerpoint. Each acoustic unit (32a-32g) employs a pendulum striker 25 (which may be of varying size, shape and weight) attached to one end of a rod or the like (27a, 27b, 27c). The opposite end of each rod (27a, 27b, 27c) is attached a housing side member (33c, 33d) or other support structure in a manner that orients the pendulum striker (25) at the centerpoint between the radially spaced-apart horizontal acoustic elements (34).

More particularly, the embodiment of FIG. 9A is similar to that of FIG. 8D (or FIG. 8A where the striker attachment member 26a is a rod) except rotated 90 degrees. In this embodiment (31a), the acoustic elements (34) are mounted from one side wall (33c) and the striker attachment rod is mounted on the opposite side wall (33d). In one embodiment, the systems of FIGS. 8A and 8D employ a rod as the striker attachment member (26a, 26b) that is identical with that used as the striker attachment member 27a in the embodiment of FIG. 9A so that such system can be employed in either vertical orientation or in a horizontal orientation.

FIG. 9B depicts an embodiment similar to that in FIG. 9A except that the acoustic members (34) and the striker attachment rod (27a) are mounted on the same side wall (here, 33d). The embodiment of FIG. 9B is similar to that of FIG. 8C (or FIG. 8B where the striker attachment member 26a is a rod) except rotated 90 degrees, and employs a rod as the striker attachment members (27a). In one embodiment, the systems of FIGS. 8B and 8C employ a rod as the striker attachment member (26a, 26b) that is identical with that used as the striker attachment member 27a in the embodiment of FIG. 9B so that such system can be employed in either vertical orientation or in a horizontal orientation.

FIG. 9C illustrates a horizontal acoustic unit (31c) employing two of the acoustic unit of FIG. 9B (32b), mounted here on opposite walls (33c, 33d) in axial alignment with each other (32c-1, 32c-2). The embodiment of FIG. 9C is similar to that of FIG. 8E except rotated 90 degrees, and employs rods as the striker attachment members (27a, 27b). In one embodiment, the system of FIG. 8E employs rods as the striker attachment members (26a, 26b) that are identical with those used as the striker attachment members (27a, 27b) in the embodiment of FIG. 9C so that such system can be employed in either a vertical or horizontal orientation.

The embodiment of FIG. 9D essentially combines the features of FIGS. 9A and 9B to employ two horizontal acoustic units (32d-1, 32d-2). In one embodiment, the systems of FIGS. 8I and 8J employ rods as the striker attachment members (26a, 26b) that are identical with those used as the striker attachment members (27a, 27c) in the embodiment of FIG. 9D so that such system can be employed in either vertical orientation or in a horizontal orientation.

The embodiment of FIG. 9E is similar to that of FIG. 9B except that it employs an additional striker (25) and striker attachment member (27b) mounted on the opposite wall (33c). The embodiment of FIG. 9E is similar to that of FIGS. 8F and 8G except rotated 90 degrees, and employing rods as the striker attachment members (27a, 27b). In one embodiment, the systems of FIGS. 8F and 8G employ rods as the striker attachment members (26a, 26b) that are identical with those used as the striker attachment members (27a, 27b) in the embodiment of FIG. 9E so that such system can be employed in either vertical orientation or in a horizontal orientation.

The embodiment of FIG. 9F is similar to that of FIG. 8H except rotated 90 degrees, and employing a rod as the striker attachment member (27a). One set of horizontal acoustic members (34a) (comprising part of unit 32f-1) are mounted from one side wall (33d) in radially spaced apart relationship about the centerpoint, and the other set of horizontal acoustic members (34b) (comprising part of unit 32f-2) are mounted axially opposite on the opposite wall (33c) in radially spaced apart relationship about the centerpoint. The lengths of, and the total number of, opposed horizontal acoustic members (34a, 34b) together forms a radially spaced apart array of acoustic members in a strike zone (29) where the striker (25) can impact the acoustic members (34a, 34b). In one embodiment, the system of FIG. 8H employs a rod as the striker attachment member (26a) that is identical with that used as the striker attachment member (27a) in the embodiment of FIG. 9F so that such system can be employed in either a vertical or horizontal orientation.

The embodiment of FIG. 9G is similar to that of FIG. 8L except rotated 90 degrees, and employing rods as the striker attachment member (27a, 27b). In one embodiment, the system of FIG. 8L employ rods as the striker attachment members (26a, 26b) that are identical with those used as the striker attachment members (27a, 27b) in the embodiment of FIG. 9G so that such system can be employed in either a vertical or horizontal orientation.

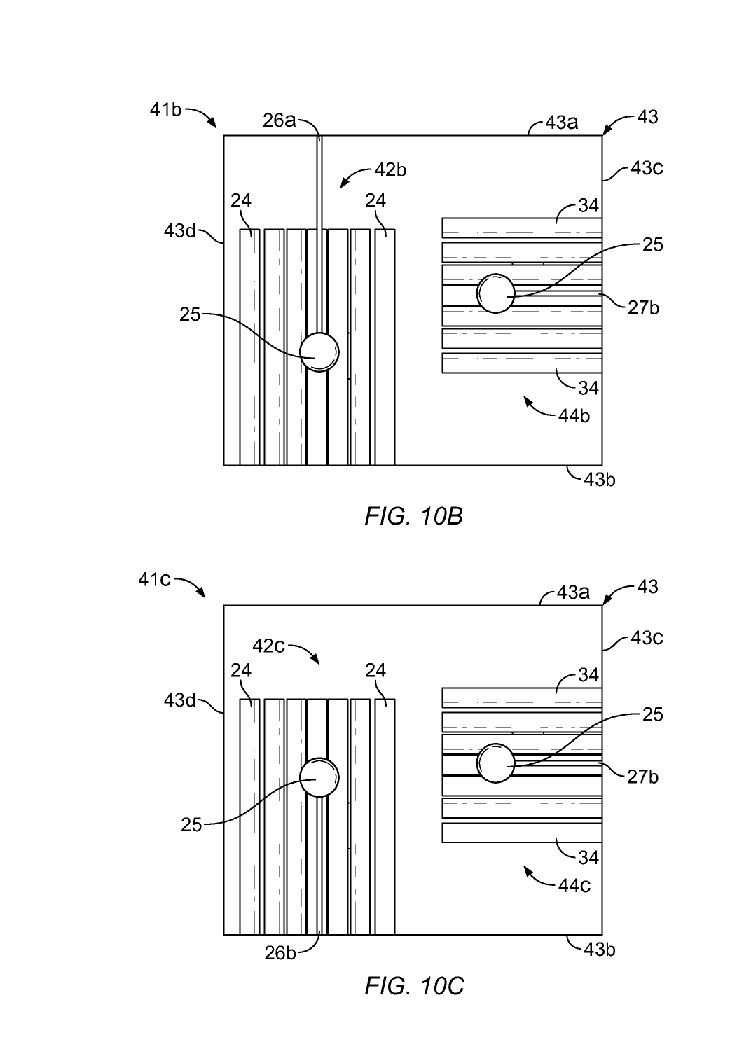

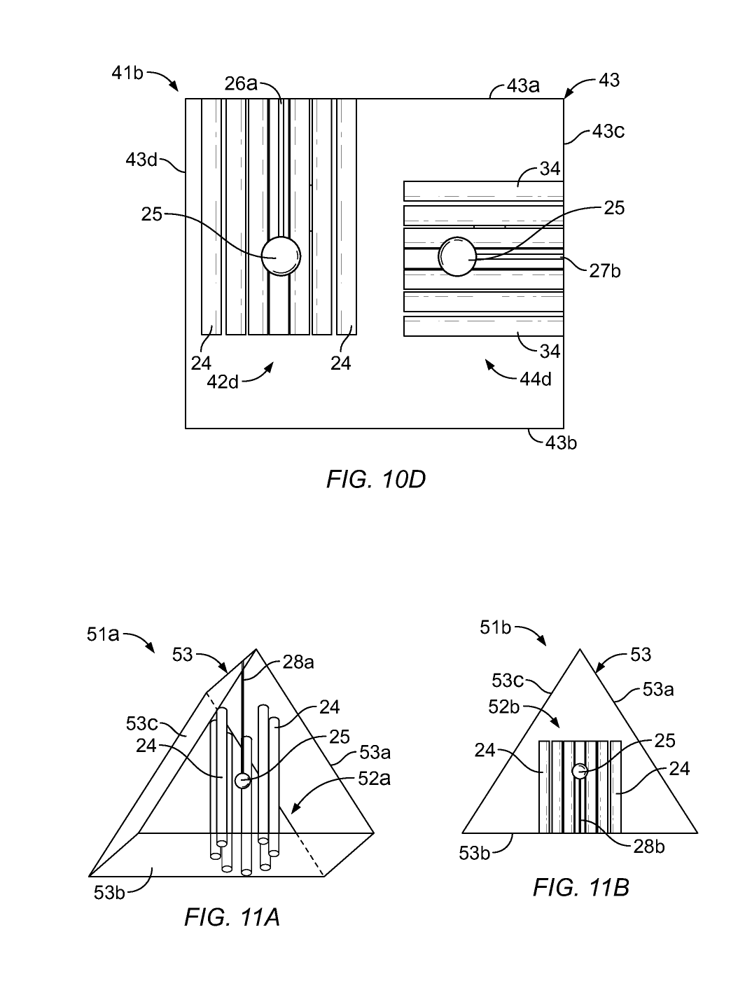

FIGS. 10A-10D depict various embodiments of combination vertical and horizontal oriented earthquake detection systems 41a-41d employing various vertical acoustic units (42a-42d) and horizontal units (44a-44d). These units employ strikers (25) that are mounted to striker attachment members (26a, 26b, 27a, 27b) as described herein. These units are housed in a suitable support structure or housing (43) generally comprising a top wall or ceiling 43a, a base 43b, and opposed side support walls or structures 43c, 43d, and additional vertical support structure 43e where indicated.

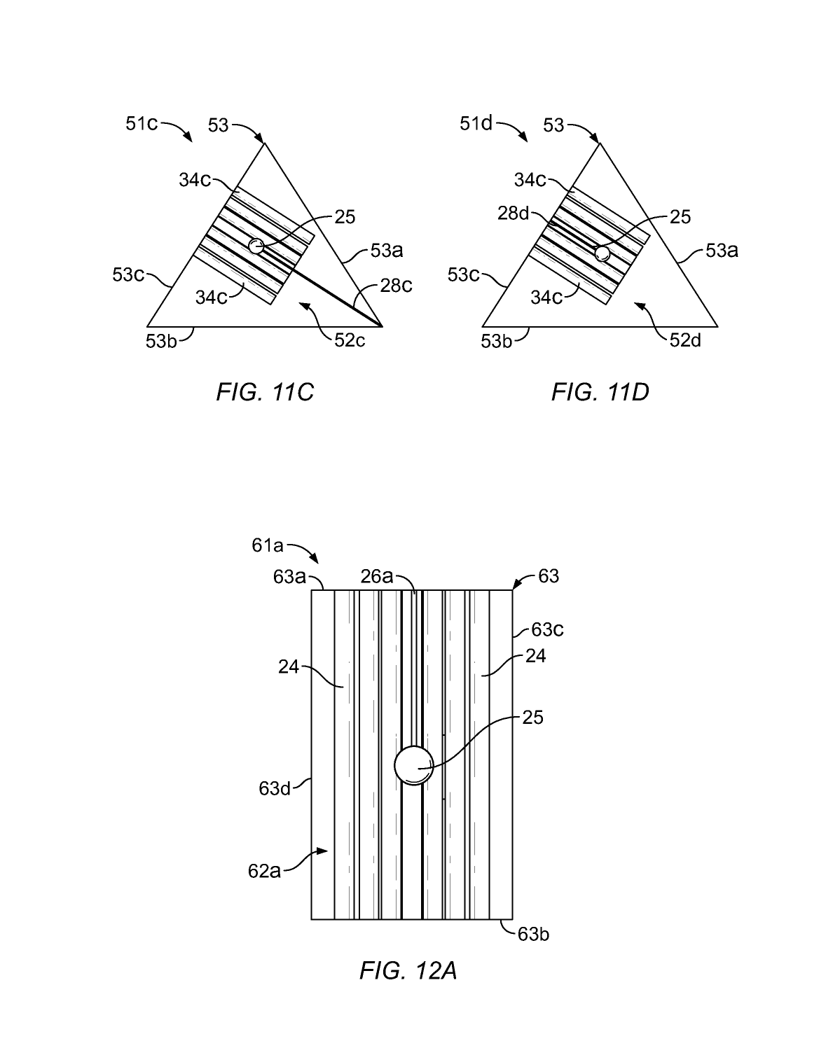

FIGS. 11A-11D depict a various earthquake detection systems (51a-51d) according other embodiments of the present disclosure. These embodiments employ a triangular support structure or housing 53 (generally comprising a triangular shape with a base member 53b, and two side members 53a, 53c.

FIG. 11A depicts a vertical acoustic unit 52a where a plurality of radially-spaced apart horizontal acoustic members (24) are mounted to the base (53b) about a centerpoint. In this embodiment, the pendulum striker (25) is attached to the striker attachment member (28a) mounted or hanging from the apex of the triangle (over such centerpoint). One or more of the acoustic member (24) have been removed to permit viewing the pendulum (striker plus striker attachment member), it being understood that in normal operation, it is preferable to have the acoustic elements (24) arranged in radial orientation spaced equidistantly from each other at a radial distance (r) from the centerpoint.

FIG. 11B depicts a similar embodiment to that in FIG. 11A except that its vertical acoustic unit (52b) employs a pendulum striker attachment member (28b) that is attached to the base (53b) at the centerpoint. It will be understood that the support structures 53a and 53c are not necessary for the embodiment of FIG. 11B.

FIG. 11C depicts an embodiment similar to that disclosed in FIG. 11A (preferably where the structure 53 is substantially an equilateral triangle in shape), except it is rotated so that side (53a) of FIG. 11A becomes the base (53b) of FIG. 11C. Thus, referring to the angular-oriented acoustic unit (52c), the acoustic elements 34c are mounted radially about the midpoint of one of the sides (53c) of the triangle, and the pendulum (striker 25 and striker attachment rod 28c) is mounted from a base corner opposite such midpoint and extends along the median to provide an angular orientation. In one embodiment, the striker attachment member (28a) in the embodiment of FIG. 11A is substantially identical with the striker attachment member (28c) of the embodiment of FIG. 11C so that this embodiment could be used in either the vertical or angular orientations.

FIG. 11D depicts a similar embodiment to that in FIG. 11C (preferably where the structure 53 is substantially an equilateral triangle in shape) except that its angular acoustic unit (52d) employs a pendulum striker attachment member or rod (28d) that is attached at the centerpoint of the side (53c) (where the acoustic elements (34c) are attached) and extends along the median to also provide an angular orientation. In one embodiment, the striker attachment member (28b) in the embodiment of FIG. 11B is substantially identical with the striker attachment member (28d) of the embodiment of FIG. 11D so that this embodiment could be used in either the vertical or angular orientations.

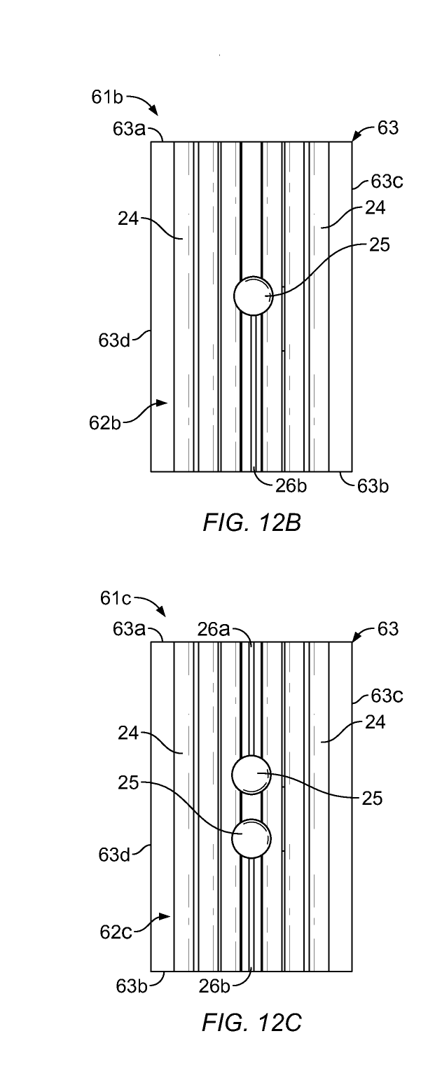

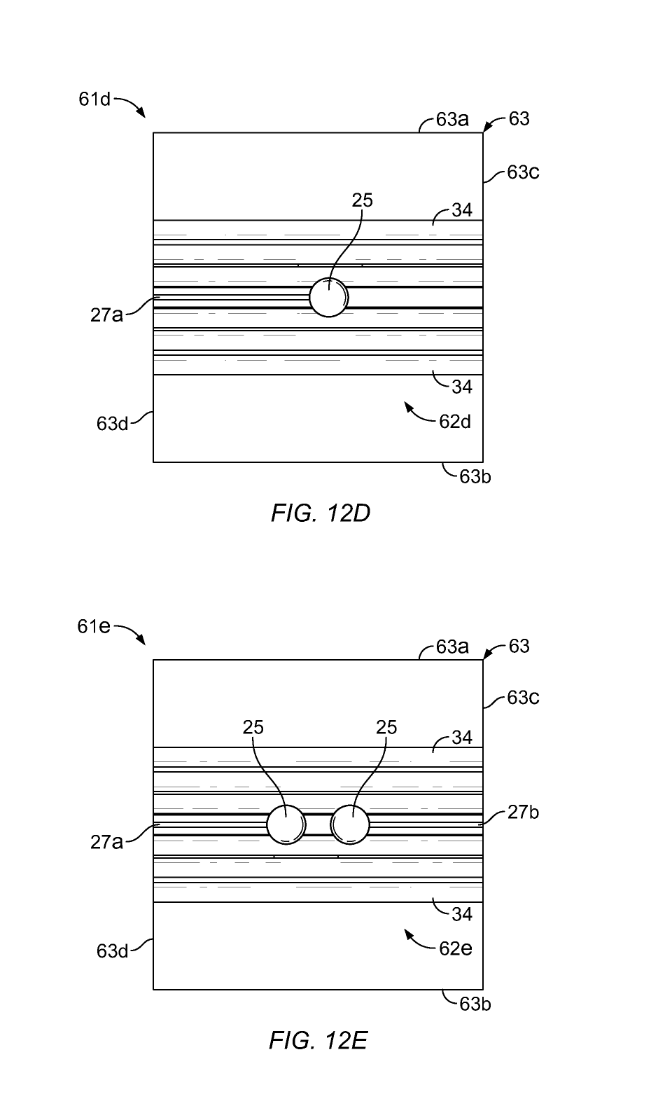

FIGS. 12A-12C generally depict various vertically oriented earthquake detection systems (61a-61c) according to other embodiments of the present disclosure. FIGS. 12D-12E generally depict various horizontally oriented earthquake detection systems (61d-61e) according to other embodiments of the present disclosure. In these embodiments, the acoustic units (62a-62e) are housed in a suitable structure or housing (63) generally comprising a top wall or ceiling 63a, a base 63b, and opposed side support walls or structures 63c, 63d. In the embodiments of FIGS. 12A-12C, the vertical acoustic members 24 are set apart in radially spaced apart orientation about a centerpoint and are attached at either end to the support structure top wall (63a) and base (63b). A pendulum striker (25) is attached to a pendulum striker attachment member (26a, 26b as described herein), which in turn is attached to the structure at the centerpoint.

In the embodiments of FIGS. 12D-12E, the horizontal acoustic members 34 are set apart in radially spaced apart orientation about a centerpoint and are attached at either end to the support structure side walls (63c, 63d). A pendulum striker (25) is attached to a pendulum striker attachment member (27a, 27b as described herein), which in turn is attached to the structure at the centerpoint. It will be understood that the support structure 63a is not necessary for the embodiments of FIGS. 12D-12E.

The earthquake detection systems of the present invention can be permanently attached to the building (e.g., mounted to the floor, wall or ceiling) or to a fixed feature or structure of the building, such as, a built in shelf or countertop (or other location for desired installation). The base member can also preferably be weighted to provide stability for the system when the system is used in a free-standing installation. The housing designs can be varied, it being preferred that the housing structure not mask or block the sound emanating from the acoustic members (when struck by the pendulum striker). It is also understood that various housing designs can be employed that provide acoustic amplification of the sound emanating from the acoustic members (when struck by the pendulum striker).

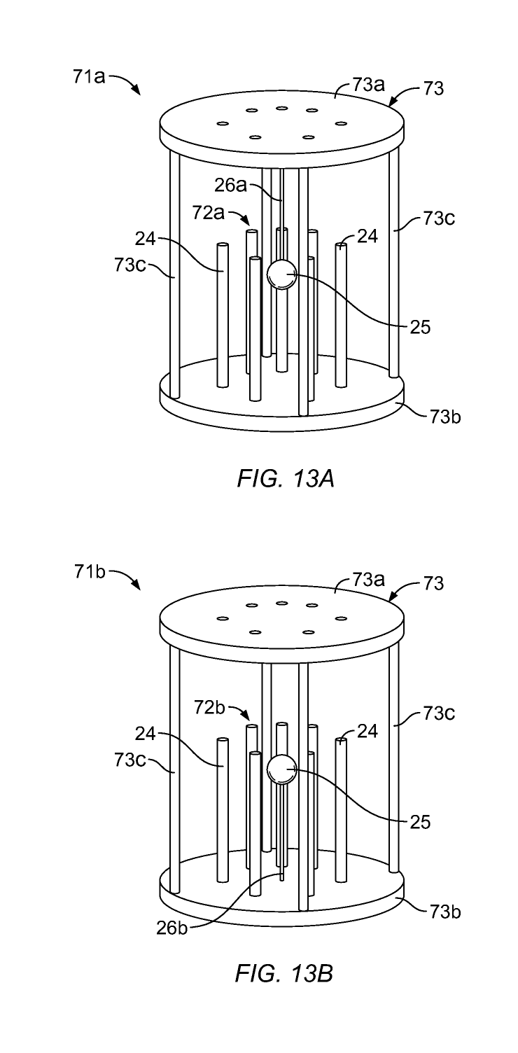

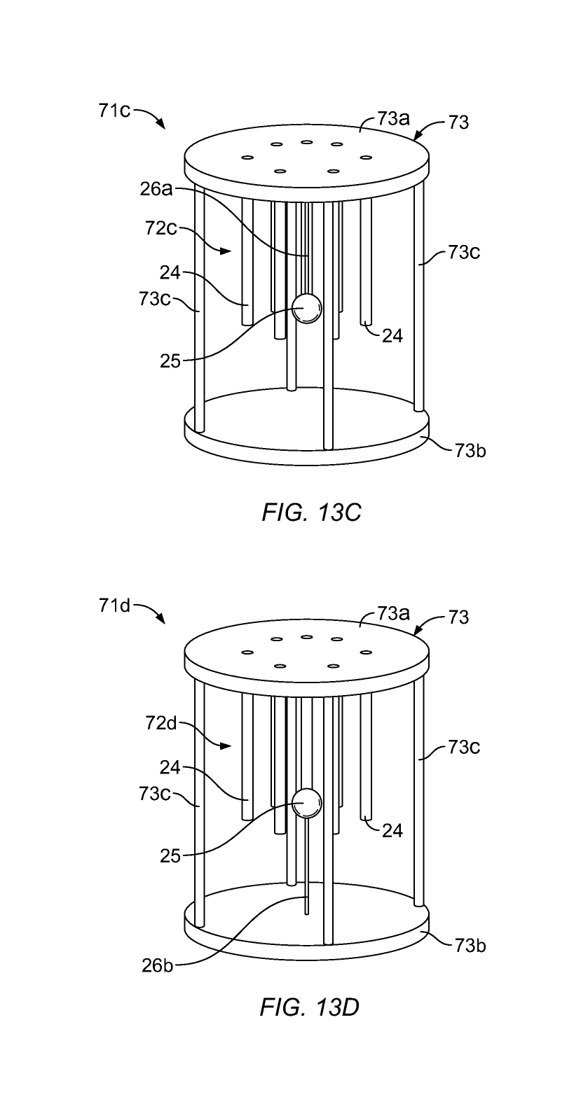

FIGS. 13A-13D provide example embodiments of vertically oriented earthquake detection systems (71a-71d) according to the present disclosure. These embodiments are similar to those depicted in FIGS. 8A-8D. In these embodiments, there is employed a support structure or housing 73 generally comprising a top member 73a, a base 73b, and one or more vertical support members 73c for housing the vertical acoustic unit (72a-72d). In FIG. 13A, like in FIG. 8A, the acoustic members 24 are mounted in radially-spaced apart fashion about a centerpoint, and are depicted here being mounted to the base 73b. The pendulum striker 25 is attached to one end of the pendulum hanging wire, cord, rope, rod or the like (26a, 26b pendulum attachment mechanism) as described herein, and the opposite end of the pendulum attachment member is attached to the structure at the centerpoint. In one embodiment, the upper member (73a) is attached above the base (73b) by a single support structure (73c) so that the seismic energy causes the support structures (73a, 73c) to move as well. It will be understood that the support structures 73a and 73c are not necessary for the embodiment of FIG. 13B.

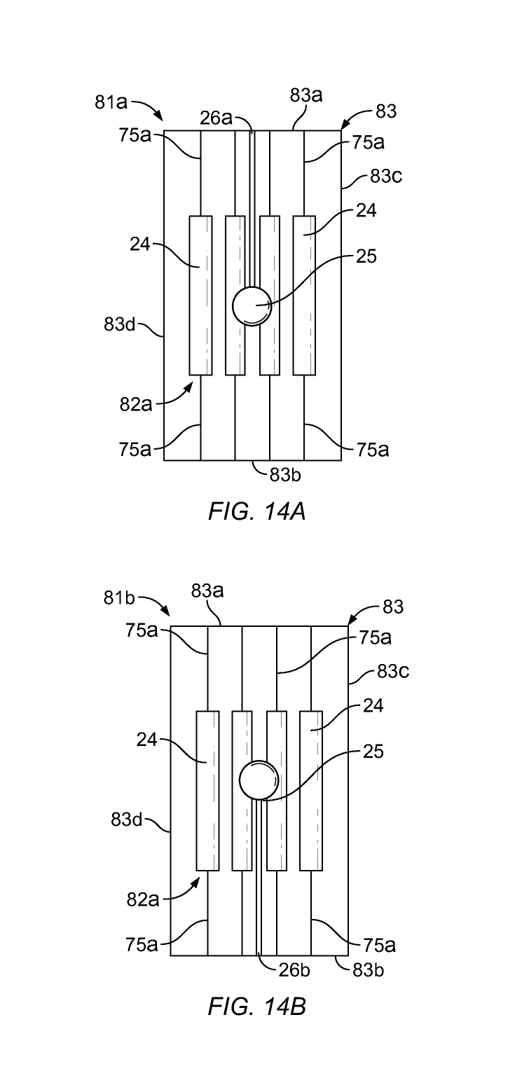

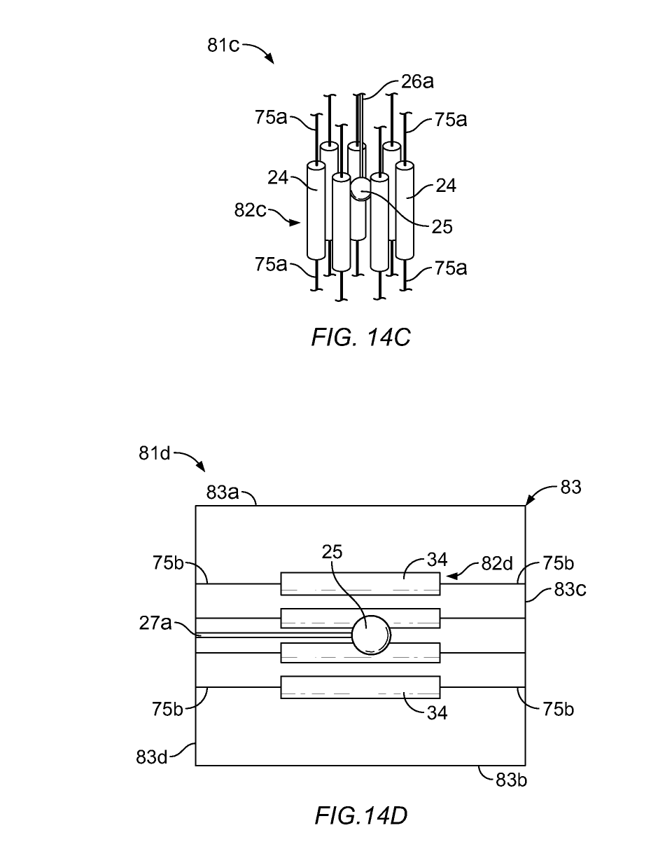

As noted above, once provided with the benefit of the present disclosure, it will become apparent that there exist many ways in which to mount the acoustic elements to the structure. FIGS. 14A-14D illustrate the use of wires, strings or lines (75a, 75b) to suspended either vertically (FIGS. 14A-14C) or horizontally (FIG. 14D) a radially-spaced array of acoustic members 24, 34 between opposed housing structure members. More particularly, FIGS. 14A-14C generally depict various vertically oriented earthquake detection systems (81a-81c) according to other embodiments of the present disclosure. FIG. 14D generally depicts a horizontally oriented earthquake detection system (81d) according to another embodiment of the present disclosure. In these embodiments, the acoustic units (82a-82d) are housed in a suitable structure or housing (83) generally comprising a top wall or ceiling 83a, a base 83b, and opposed side support walls or structures 83c, 83d (or other suitable structure).

In the embodiments of FIGS. 14A-14C, the vertical acoustic members 24 are set apart in radially spaced apart orientation about a centerpoint and are suspended between the support structure top wall (83a) and base (83b) using wires, strings or lines (75a) attached to the support structure top wall (83a) and base (83b). The acoustic units (82a, 82c) of the embodiments of FIGS. 14A and 14C, also comprise a pendulum striker (25) attached to a pendulum striker attachment member (26a as described herein), which in turn is attached to the structure top wall 83a at the centerpoint. In another embodiment of FIGS. 14A and 14C, if a rod is used as the striker attachment member 26a, then such embodiment could be rotated 180 degrees to serve as the embodiment shown in FIG. 14B, and thereby provide the option to use the unit in either vertical orientation (or as will be discussed below, in the horizontal orientation depicted in FIG. 14D) thereby increasing the versatility of end use for a single embodiment design.

In the embodiment of FIG. 14D, the horizontal acoustic members 34 are set apart in radially spaced apart orientation about a centerpoint and are suspended between the support structure side walls (83c, 83d) using wires, strings or lines (75b) attached to the support structure side walls (83c, 83d). The acoustic unit (82d of the embodiments of FIG. 14D, also comprises a pendulum striker (25) attached to a pendulum striker attachment member (27a as described herein, e.g., a flexible rod), which in turn is attached to the structure side wall 83d at the centerpoint. It will be understood that the support structure 83a is not necessary for the embodiment of FIG. 14D. Where the embodiments of FIGS. 14A and 14B use a flexible rod as the pendulum striker attachment member (26a, 26b), then the embodiment of FIG. 14D is essentially that of FIGS. 14A and 14B rotated 90 degrees.

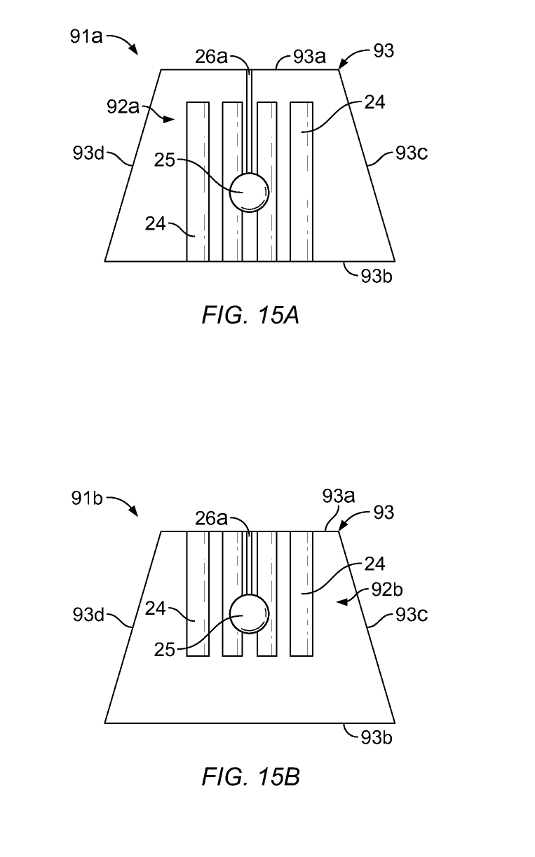

FIGS. 15A-15B provide example embodiments of vertically oriented earthquake detection systems (91a-91b) according to the present disclosure. These embodiments are similar to those depicted in FIGS. 8A and 8B, respectively, except employ a support structure 93 of a generally trapezoidal outer shape generally comprising a top wall or ceiling 93a, a base 93b, and two angular side walls 93c, 93d that contains the acoustic units (92a, 92b).

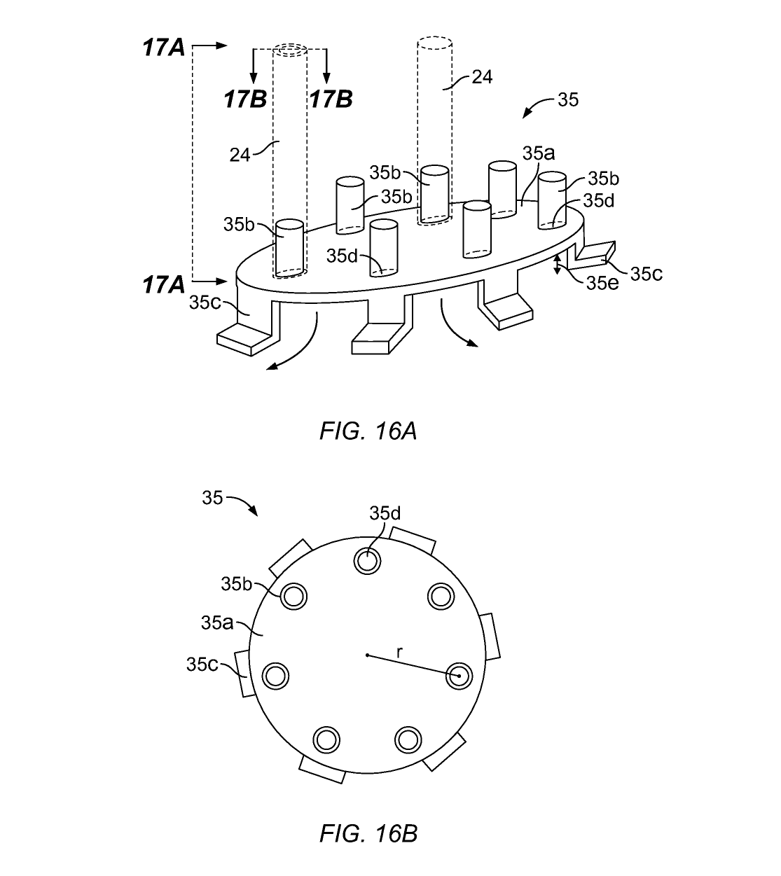

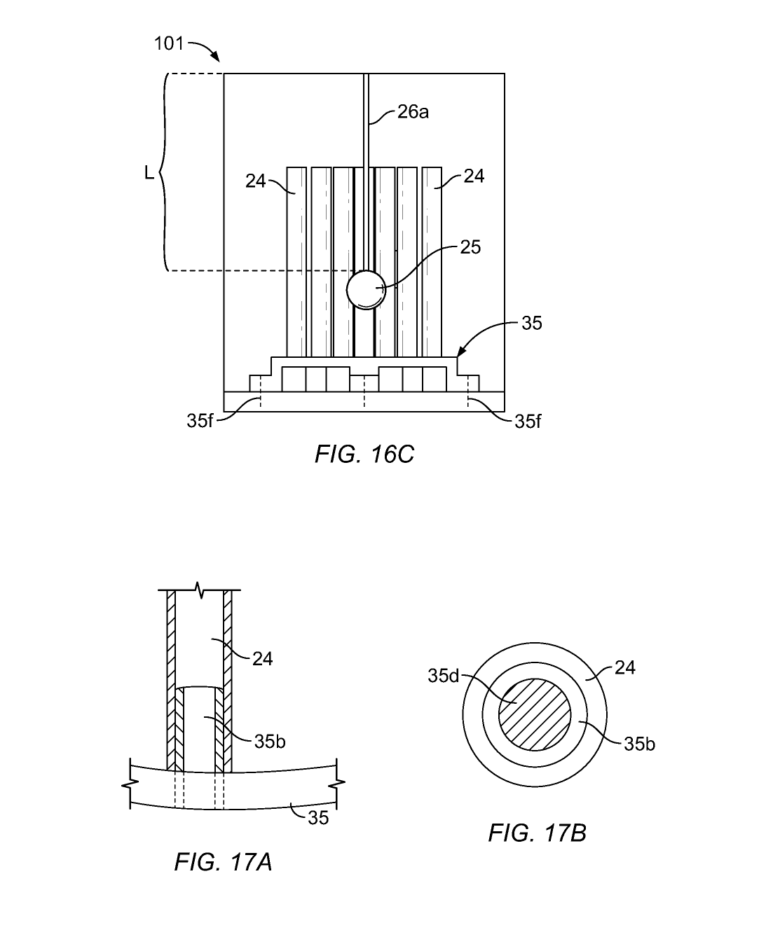

Referring now to FIGS. 16A-17B, there is illustrated another mounting system 35 for holding the acoustic members (hollow chimes) 24 in the desired location. In this embodiment, the acoustic mounting member 35 comprises an elevated platform 35a supported by mounting feet members 35c having a height 35e. Extending upward from the platform 35a is a plurality of mounting cylinders 35b that are radially spaced apart from each other about a centerpoint defining a radius (r). The mounting cylinders 35b are preferably tubular members mounted about an aperture (35d) in the platform 35a, but could be solid. The mounting cylinders (35b) have an outer diameter capable of receiving the inner diameter of a hollow chime (24) in mated relationship (including that sufficient to achieve an interference fit). The chimes (24) can be mounted on the cylinders (either permanently, using adhesives, set screws and other attachment techniques, and the like or removably using interference fit, cotter pins, and the like). The platform 35a is shown in a circular outer shape, but could be any shape that can receive the plurality of mounting cylinders in the desired radially-spaced apart configuration. In another embodiment, the mounting cylinders receive the chimes (24) within the internal diameter of the cylinder. FIG. 16C shows an example vertically oriented earthquake detection system (101) employing the acoustic member mounting system 35, shown here mounted to the base of the system using standard mounting techniques, such as adhesives, screws or nails (35f).

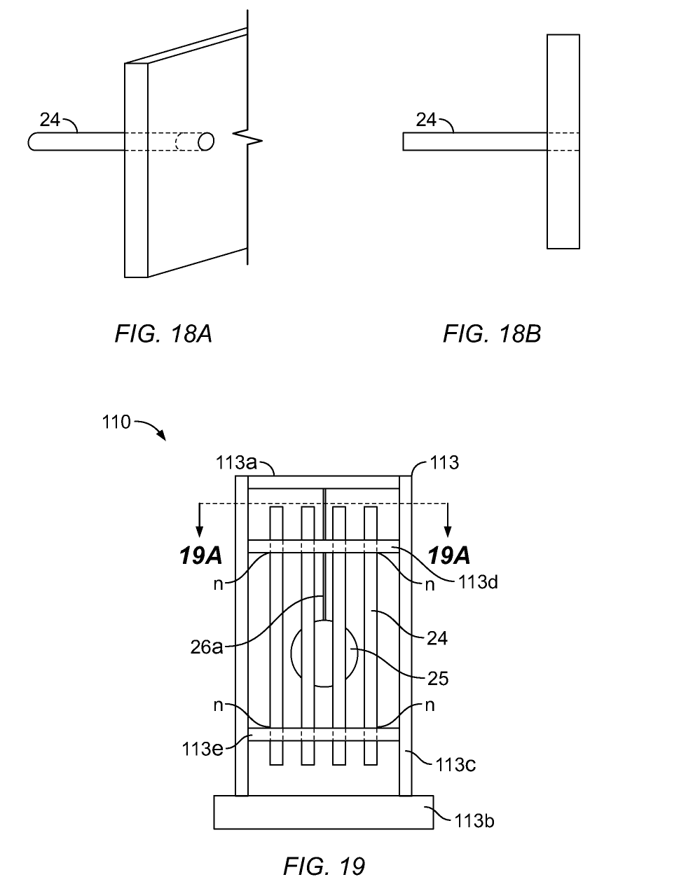

FIGS. 18A-18B show, by way of further illustration, an acoustic member tube or chime (24) mounted directly into a structural wall or base member as described herein.

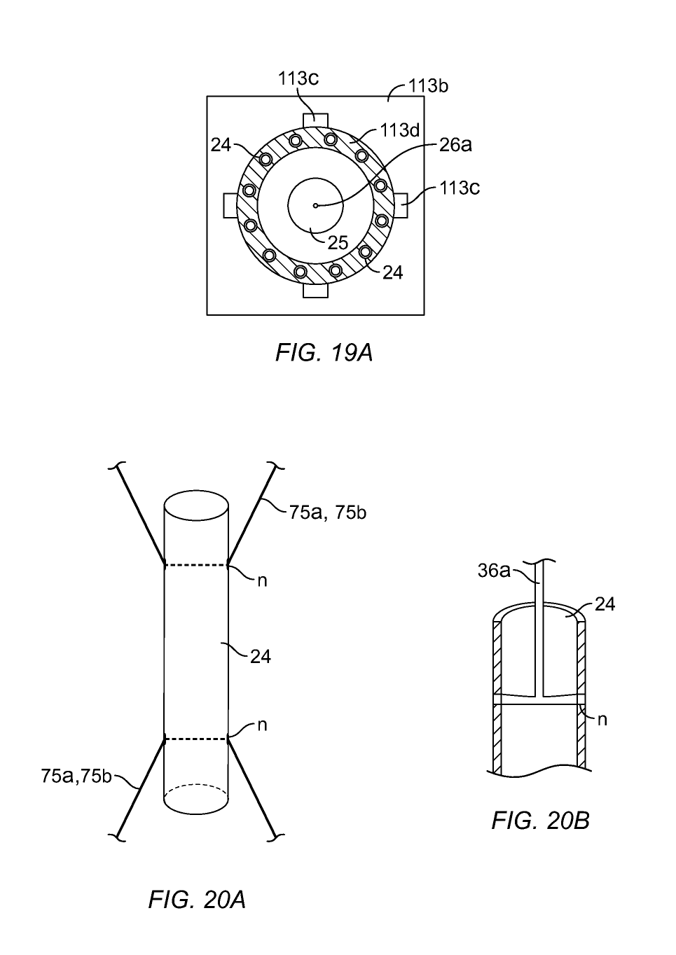

FIGS. 19-19A depict a vertically oriented earthquake detection system (110) according to another embodiment of the present disclosure employing a support structure (113) generally comprising a base member 113b, top wall or ceiling structure 113a, and one or more vertical support structures 113c. Upper and lower mounting structures 113d and 113f are attached to the one or more vertical support structures 113c and serve to hold in place the acoustic members 24 at their respective upper and lower nodal points (n).

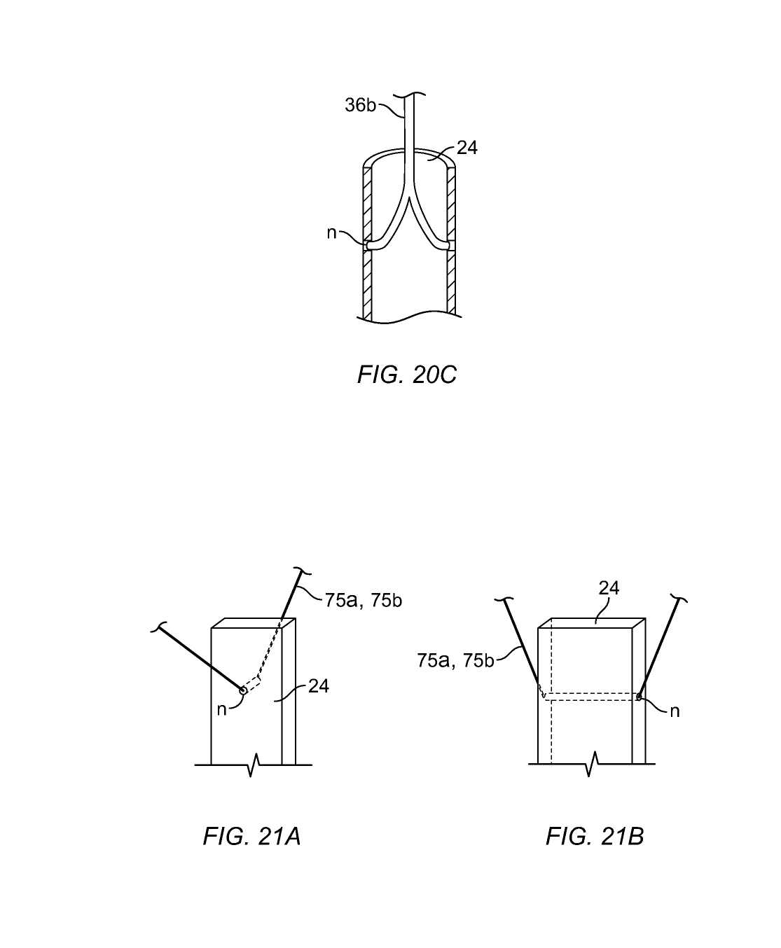

FIG. 20A shows an acoustic member mounting mechanism where wires, string, cord or the like (75a, 75b) are run through the upper and lower nodal points (n) of the acoustic member 24, here a chime (either hollow or solid) to mount the chime to a structure (not shown).

FIG. 20B illustrates a mechanism for mounting a hollow chime (24) at one of its nodal points (n) from the interior of the chime, such as generally taught by Kile et al., U.S. Pat. No. 6,111,178. In this embodiment, the chime has two transvers divots or apertures at the nodal point (n) for receiving a mounting rod 36a. Similarly, FIG. 20C illustrates a mechanism for mounting a chime at one of its nodal points (n) from the interior of the chime using another mounting rod variation 36b.

FIGS. 21A-21B illustrate an acoustic member mounting mechanism where wires, string, cord or the like (75a, 75b) are run through one of the nodal points (n) of the acoustic member 24, here a solid bar, to mount the chime to a structure (not shown).

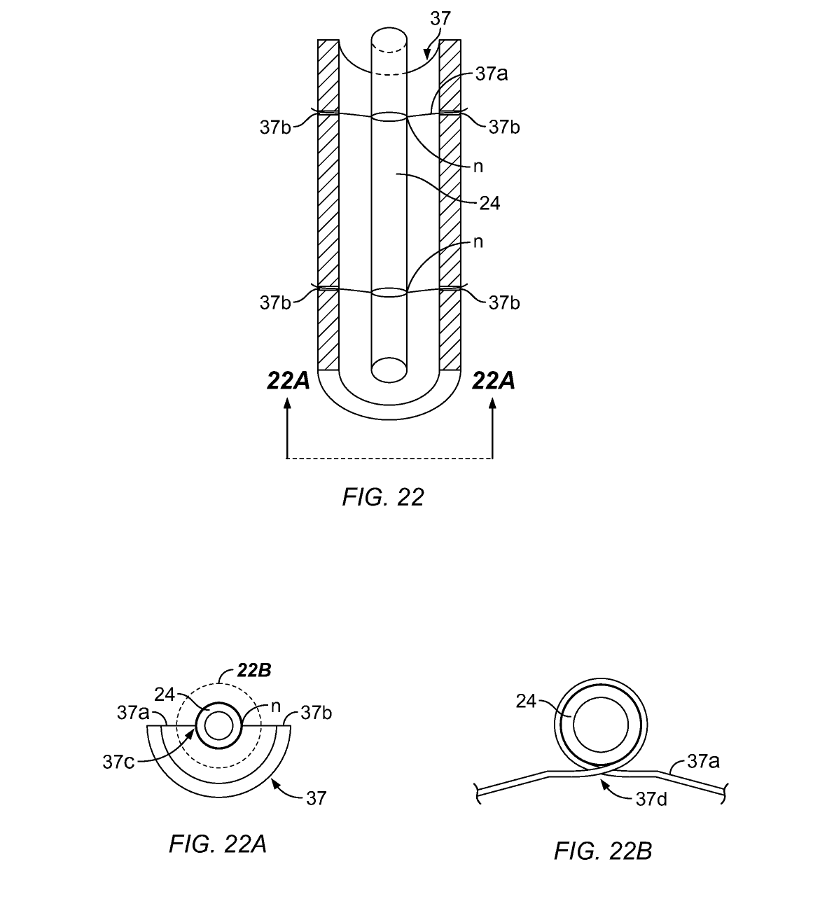

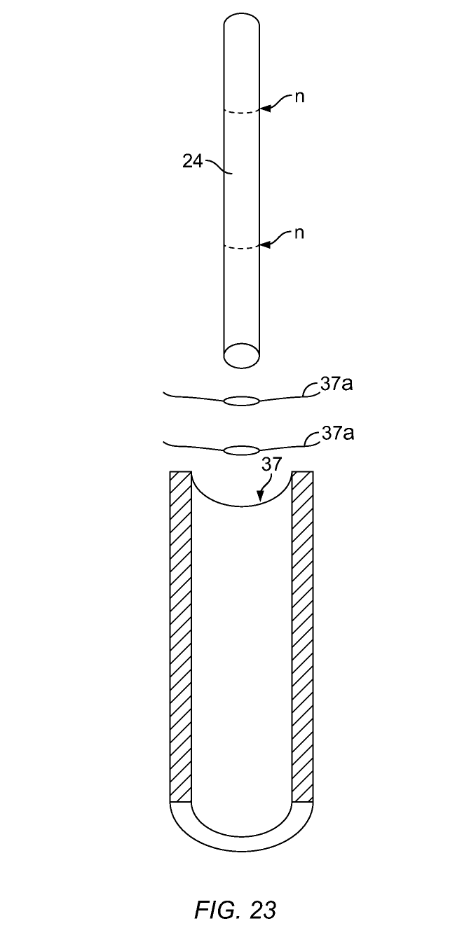

FIGS. 22-23 show an acoustic member, such as solid tube, hollow chime, or solid bar 24 (shown here as a hollow tube), mounted in suspension (here, over an open channel (37)) using wire (37a) around the nodal points (n) of the acoustic member 24. The ends of the ends of the wire 37a are attached to the channel at mounting points 37b. In the configuration of FIG. 22A, the wire 37a suspends the tube 24 at its transverse midpoint 37c. In the enlarged view in FIG. 22B, the wire 37a suspends the tube 24 at its lower tangent, 37c.

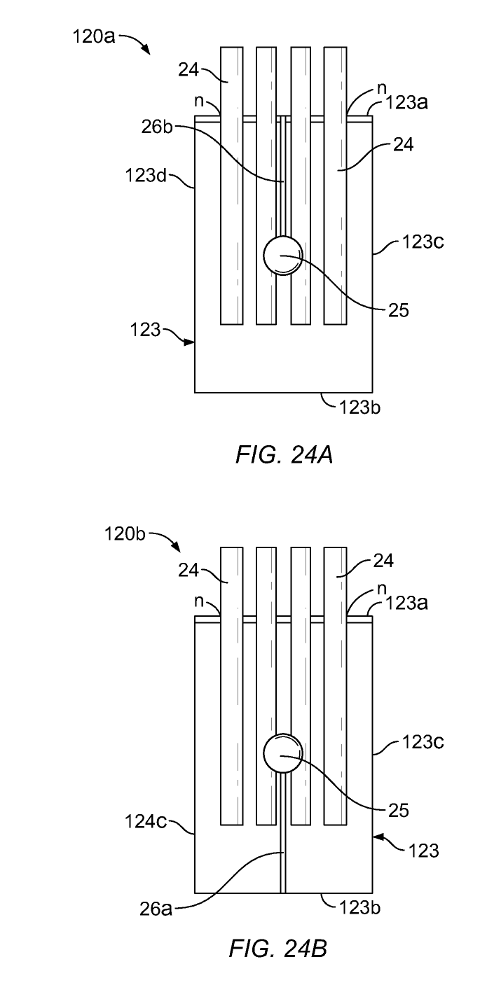

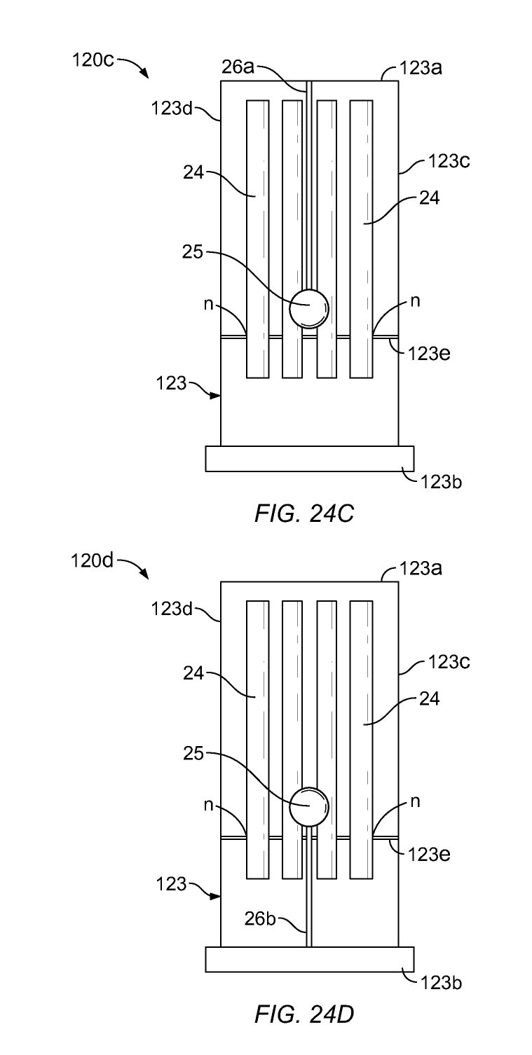

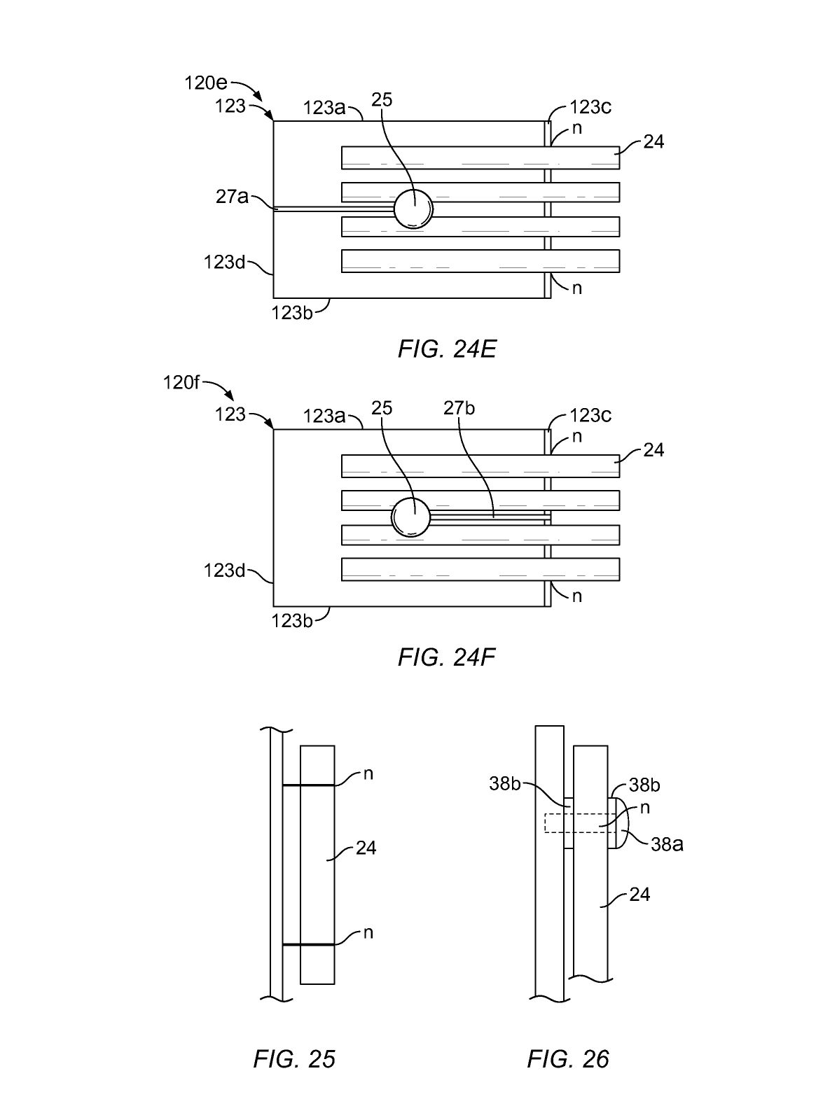

FIGS. 24A-24D depict various embodiments of a vertically oriented earthquake detection system (120a-120d) according to another embodiment of the present disclosure employing a support structure (123) generally comprising a base member 123b, top wall or ceiling structure 123a, and one or more vertical support structures 123c, 123d. Acoustic members (122a-122d) are housed in support structure 123. In FIGS. 24A and 24B, the radially spaced apart acoustic members 24 are attached at their upper nodal points (n) to the top wall 123a. In FIGS. 24C and 24D, mounting structure 123e is attached to the one or more vertical support structures 123c, 123d and serves to hold in place the acoustic members 24 at their respective lower nodal points (n).

FIGS. 24E-24F depict various embodiments of a horizontally oriented earthquake detection system (120e-120f) according to another embodiment of the present disclosure employing a support structure (123) generally comprising a base member 123b, top wall or ceiling structure 123a, and one or more vertical support structures 123c, 123d. In FIGS. 24E and 24F, the radially spaced apart acoustic members 24 are attached at nodal points (n) to the side wall or support structure 123c.

FIG. 25 illustrates an example for connecting an acoustic element (e.g., hollow or solid tube, solid bar, etc.) 24, at its nodal points (n), to a structure. FIG. 26 shows an example for connecting a solid acoustic bar (24), at one of its nodal points (n), to a structure. In this embodiment, the bar (24) has an apertured opening to receive a screw 38a (or other fastener). As may be desired, a grommet (38b) made out of rubber, plastic or other suitable material, is secured therebetween.

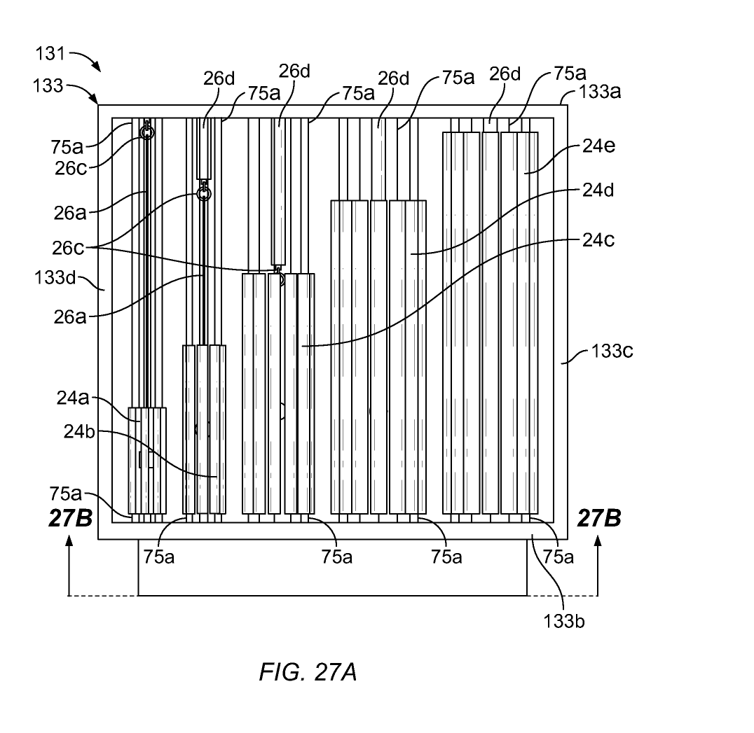

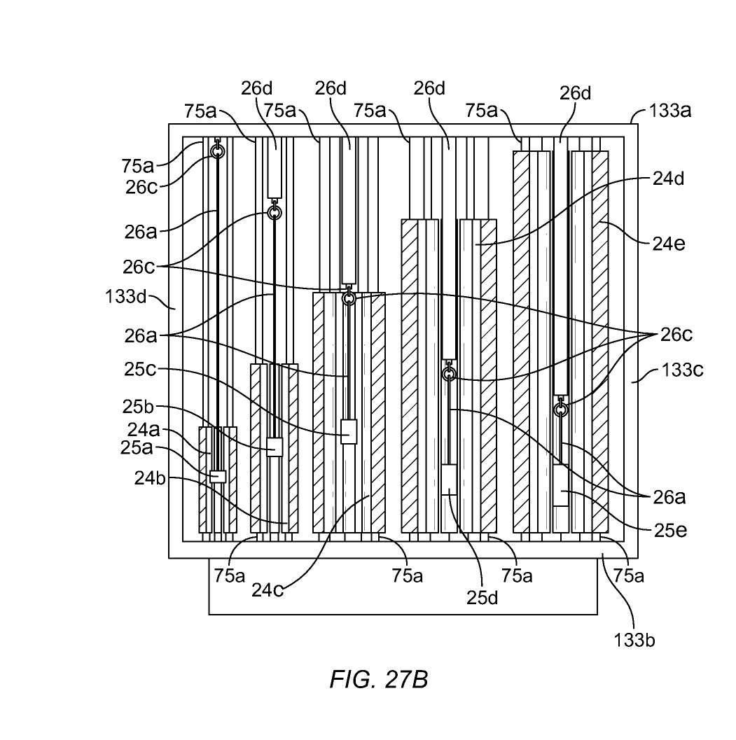

Referring now to FIGS. 27A and 27B, there is depicted an exemplary vertically oriented earthquake detection system (131) according to one embodiment of the present disclosure employing five different acoustic units. In this embodiment, a housing (133) is provided generally comprising an upper or top support structure (133a), a base (133b), and two vertical support members (133c, 133d) therebetween. Each acoustic unit comprises a radially spaced apart group of different-sized acoustic members (24a-24e) that are suspended (by wires or string 75a) from their upper and lower nodal points (n) in radial fashion about a pendulum striker system (39) located along the radial centerpoint. The pendulum striker system comprises a pendulum striker (of varying size, weight and dimensions, 25a-25e) and a pendulum striker attachment mechanism (26a) for connecting the striker (25a-25e) to the centerpoint, and is designed to permit movement of the striker as a simple pendulum, physical pendulum, conical pendulum, complex pendulum, or combinations thereof in response to the seismic activity in an earthquake. In some instances, the pendulum striker attachment mechanism may be a hanging wire, line, cord, rope, rod or the like. In this embodiment, the line or string 26a can be attached to the structural member 133a by a connector 26c, such as an eye hook, eye bolt, clip, or other fastener (or the like). To permit greater flexibility in designing the overall pendulum system, additional structural support members 26d (of varying lengths) may be employed to permit adjustment of the overall length of the pendulum striker attachment member. For example, with an exemplary system as shown in FIGS. 17A and 27B, it is possible to design the system to calibrate the smallest acoustic unit (using chimes 24a) to respond to the lowest magnitude earthquake, while the largest (e.g., that using chimes 24e) will respond to the highest magnitude.

As such, in case of an earthquake of magnitude 5 only sound would be uniquely produced by acoustic elements 24a (sound level 1). In case of an earthquake of magnitude 6, the acoustic element 24a will be engaged and produce sound at sound level 1, and as the intensity of the earthquake increases, acoustic element 24b will also begin ringing to create a louder sound (sound level 2). When the earthquake reaches magnitude 7, acoustic element 24c will also begin emitting a sound (in combination with acoustic elements 24a and 24b) to create a louder sound (sound level 3). When the earthquake reaches magnitude 8, acoustic element 24d will also begin emitting a sound (in combination with acoustic elements 24a, 24b, and 24c) to create a louder sound (sound level 4). When the earthquake reaches magnitude 9, acoustic element 24e will also begin emitting a sound (in combination with acoustic elements 24a, 24b, 24c, and 24d) to create the loudest sound (sound level 5). The intensity of the sound emitted can be calibrated to permit, e.g., a sleeping person to be awakened by the sound emitted by the earthquake detection system.

As will be understood by those having the benefit of the present disclosure, the length of the pendulum (L) (as defined as being the length of the pendulum striker attachment member between the pendulum striker or bob (25) and the point of attachment to the structure) can be varied, as can the size, weight and geometry of the striker. The radial distance from the centerpoint (defining the circumference or circle about which the acoustic members 24 are spaced) can also be varied, as can the spacing of acoustic members about the striker. The size, diameter, length and type of material used for the acoustic members can also be varied to provide the ability to create a fine-tuned set of earthquake detector acoustic units that respond to different magnitudes of seismic earthquake energy. The variability in the design of the present invention provides great flexibility to construct a system that is optimally calibrated.

In other alternative embodiments, the structure for securing each acoustic element can be flexible to permit the acoustic elements to impact each other as well as to be impacted by the pendulum striker during an earthquake.

The design of the acoustic units may vary in dimensions and specifications such as, for example: the diameters and length of the chimes, the diameters and thickness of the tubes, the length of the pendulum wire, cord and/or rod, the size and weight of the pendulum striker, and so on. These variations will allow use of a plurality of different acoustically tuned chimes such that the sound of different chimes become activated in a gradual way as the time of the earthquake magnitude increases, so at the beginning of the earthquake it will sound only one chime (or chimes tuned to low earthquake magnitude), and when the earthquake has intensified in its magnitude, the alarm will sound two or three chimes (or those chimes tuned to higher earthquake magnitudes), and finally when the earthquake had finally reached it maximum magnitude, four or five chimes will sound (or those chimes tuned to high earthquake magnitudes). Because earthquakes can have a duration of less than 1 minute to 3 minutes or more, the gradual way in which this embodiment detects earthquakes allows those in proximity to the alarm to receive the first warning sign with any small movement of land, drawing their attention and alerting them as the magnitude of the earthquake and number of chimes playing increases in the earthquake detector. For example, this earthquake detector could be tuned to be triggered to sound the first chime for vibrations as low as those created by the passage of a train or heavy trailer on the street next to an apartment building, so that the earliest stages of an earthquake will immediately be called to the attention of building occupants.

A few examples are described herein and depicted in the drawings, but they are only that, an example. However, variations are possible within the spirit and scope of the present disclosure. For example, any number of acoustic elements, sounding with different earthquakes intensities, could be employed, for example, and without limitation, an apparatus having ten acoustic elements sounding in progressive order with earthquakes of Mw=5.0, Mw=5.5, Mw=6.0, Mw=6.5, Mw=7.0, Mw=7.5, Mw=8.0, Mw=8.5, Mw=9.0, Mw=9.5, and the like.

It is also envisioned that the size of the earthquake detection devices of the present disclosure can be varied depending on the application. For example, a small personal portable unit (vertically-oriented, horizontally-oriented or combination vertically/horizontally-oriented) could be constructed for travel, e.g., a small alarm that one could carry in a suitcase to bring into one's hotel room. A medium sized unit (vertically-oriented, horizontally-oriented or combination vertically/horizontally-oriented) could be constructed for home or office use. Also, a large unit (vertically-oriented, horizontally-oriented or combination vertically/horizontally-oriented) could be constructed for use in cinemas, theaters, hospitals, malls, hotels, etc.

It is also envisioned that a separate vertically-oriented earthquake detection system could be used in tandem with a horizontally-oriented earthquake detection system, rather than having the two systems present in the same structural housing (i.e., the combination unit described herein).

Furthermore, a horizontally-oriented earthquake detection device (with the flexible rod-like pendulum striker attachment structure) could be constructed where the sides, top and base housing structures are the same and where a separate weighted unit is attachable to a desired location on the housing structure so that one could choose to orient the unit to be horizontally-oriented (where the weights would be attached to the lower structure serving as the base to create the weighted base) or alternatively, to rotate the unit to be vertically-oriented, again, where the weights would be attached to the lower structure serving as the base to create the weighted base.

The “Earthquake gravitational alarm” of the present disclosure is different from a wind chime or wind bell because in the present apparatus, the connection between the acoustic elements and the structural framework is rigid, while the connection between a wind chime or wind bell and its supporting framework is articulated. The wind can move a wind bell or wind chime, but it will not move the acoustic unit of the present invention. Due to the rigid connection between the support frame and the acoustic unit(s) of the present invention, when an earthquake occurs, the ground movement causes movement, in the same horizontal and/or vertical direction, of the frame and acoustic unit of the present invention. In case of an earthquake, the support of a wind chime or a wind bell moves along with the land, but due to the articulation of its connection to the support, the wind chime and/or wind bell remains static, working as a pendulum, thus, when the wind chime support moves back along with the earth, the wind chime or wind bell moves in the opposite direction. During an earthquake, in the present invention, the earth, the structural frame and the chime (acoustic elements) always move in the same direction and in a synchronized manner with the earth's movement. The wind chime and/or wind bell work as a pendulum in reference to the structural frame that supports them because the connection between the wind bell or chime is articulated, and therefore, the support and chime do not move together. The acoustic units of the present invention are not pendulums, and are not employed as pendulums in relation to the structural frame, because the connection between the frame and the acoustic units is rigid causing the chime and support to move together. In a wind chime or a wind bell, the pendulum moves to impact the acoustic element; in the present apparatus, earthquakes move the frame/support structure, then the frame moves the acoustic element and the acoustic element then impacts against the pendulum which by its inertia was kept still at initial earthquake movement.

In the present invention, the bottom or base of the alarm device support structure is preferably weighted with a heavy material to provide stability to the device to prevent or minimize the risk that the device would fall during an earthquake thereby disabling the device. The rest of the structural frame is preferably of a lighter, but rigid material to create a rigid framework to house the acoustic units. Alternatively, the alarm support structure could be securely fastened in place in a desired location to prevent the movement of the earthquake from causing the alarm device to fall. For example, the structure could be mounted in place using screws, bolts, or other suitable fasteners. Also, the unit could be secured in place using a releasable mounting system, for example, a clamping system that could be used to securely (but removably) attach the alarm unit to a table, shelf, night stand, or other object that would not be prone to fall during an earthquake (i.e., remain substantially fixed in place relative to the earth), but would otherwise mirror the earth movements caused by an earthquake. As such, the alarm device remains fixed relative to the structure it is sitting on, and that when the structure (e.g., floor, bookshelf, etc. where device is sitting) moves with the earthquake, then the alarm device moves accordingly, but, because of the initial equilibrium position of the weighted striker, the weighted striker tends to stay in place relative to the rest of the device until the device's acoustic members strike the striker. In a wind bell or wind chime, wind moves the acoustic element; in the present apparatus, wind has no function, all movement comes from an earthquake.

All references referred to herein are incorporated herein by reference. While the apparatus, systems and methods of this invention have been described in terms of preferred or illustrative embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

I claim:

1. A combination vertically- and horizontally-oriented earthquake detection system comprising:
a. a frame structure comprising
i. a substantially horizontally-oriented base member,
ii. a top support member spaced apart from the base member, and
iii. one or more substantially vertical support members connected between the top support member and the base member;
b. a vertical acoustic unit comprising
i. a plurality of vertical acoustic elements, each having opposed upper and lower ends and an external striking surface capable of emitting a sound audible to humans when impacted by a pendulum striker,
ii. a vertical acoustic unit support structure for mounting the plurality of vertical acoustic elements to the frame structure in a location between the top support member and the base member, the plurality of vertical acoustic elements being positioned in a substantially vertical orientation in a spaced-apart relationship at a radial distance from a first centerpoint to form a substantially cylindrical array of vertically-oriented acoustic elements, the external striking surfaces of the plurality of mounted vertical acoustic elements being directed towards the first centerpoint; and
iii. a pendulum comprising a cord having an upper cord end and a lower cord end defining a cord length, the upper cord end being attached to an attachment point on the top support member directly above the first centerpoint, and a pendulum striker attached to the lower cord end, the striker having a desired mass and external surface capable of causing one or more of the plurality of vertical acoustic elements to emit a sound audible to humans upon impacting the external striking surface of the one or more of the plurality of vertical acoustic elements, the cord length being sufficient to permit the pendulum striker to impact one or more of the striking surfaces of the vertical acoustic elements; and
c. a horizontal acoustic unit comprising
i. a plurality of horizontal acoustic elements, each having opposed ends and an external striking surface capable of emitting a sound audible to humans when impacted by a pendulum striker,
ii. a horizontal acoustic unit support structure for mounting the plurality of horizontal acoustic elements to the frame structure, the plurality of horizontal acoustic elements being positioned in a substantially horizontal orientation relative to the one or more substantially vertical support members in a spaced-apart relationship at a radial distance from a second centerpoint to form a substantially cylindrical array of horizontally-oriented acoustic elements, the external striking surfaces of the plurality of mounted horizontal acoustic elements being directed towards the second centerpoint; and
iii. a pendulum comprising a flexible rod having an first rod end and a second rod end defining a rod length, the first rod end being attached to an attachment point on one of the one or more substantially vertical support members in coaxial relationship with the cylindrical array of horizontally-oriented acoustic elements along the second centerpoint, and a pendulum striker attached to the second rod end, the striker having a desired mass and external surface capable of causing one or more of the plurality of horizontal acoustic elements to emit a sound audible to humans upon impacting the external striking surface of the one or more of the plurality of horizontal acoustic elements, the rod length being sufficient to permit the pendulum striker to impact one or more of the striking surfaces of the horizontal acoustic elements.

2. The earthquake detection system of claim 1 further comprising more than one vertical acoustic unit.

3. The earthquake detection system of claim 2 wherein the more than one vertical acoustic units are of different sizes.

4. The earthquake detection system of claim 1 further comprising more than one horizontal acoustic unit.

5. The earthquake detection system of claim 4 wherein the more than one horizontal acoustic units are of different sizes.

6. The earthquake detection system of claim 1 wherein the vertical acoustic elements and horizontal acoustic elements are selected from the group consisting of tubes, tubular chimes, bells, solid rods, and bars.

7. The earthquake detection system of claim 6 wherein the vertical acoustic elements and horizontal acoustic elements are constructed out of acoustic materials selected from the group consisting of metal, metal alloys, steel, copper, aluminum, high-copper alloys, duraluminum, wood, hardwood, Honduran Rosewood, Cardinal wood, Purpleheart wood, African Padouk, Oak, Durian, Meranti, glass, ceramic materials, synthetic thermoplastic materials, glass fiber reinforced synthetic materials, and ceramic reinforced synthetic materials.

8. The earthquake detection system of claim 1 wherein the vertical acoustic elements and horizontal acoustic elements are mounted to their respective support structures in a manner that minimizes any damping of the audible sound emitted from the acoustic elements.

9. The earthquake detection system of claim 1 wherein the vertical acoustic elements and horizontal acoustic elements are metal tubular chimes, each chime having one or more nodal points that may serve as points of attachment for attaching the acoustic elements to the support structure.

10. The earthquake detection system of claim 9 wherein the support structure and tubular chime are coaxial.

11. The earthquake detection system of claim 1 wherein the frame structure serves as the support structure for mounting the acoustic elements.

12. The earthquake detection system of claim 1 wherein the lower end of each vertical acoustic element is attached to the vertical acoustic unit support structure and the support structure is in turn attached to the frame structure.

13. The earthquake detection system of claim 1 wherein the upper end of each vertical acoustic element is attached to the vertical acoustic unit support structure and the support structure is in turn attached to the frame structure.

14. The earthquake detection system of claim 1 wherein the upper and lower ends of each vertical acoustic element are attached to the vertical acoustic unit support structure and the support structure is in turn attached to the frame structure.

15. The earthquake detection system of claim 1 wherein the lower end of each vertical acoustic element is attached directly to the base member in a manner that does not dampen the sound emitted from the vertical acoustic element.

16. The earthquake detection system of claim 1 wherein the upper end of each vertical acoustic element is attached directly to the top support member in a manner that does not dampen the sound emitted from the vertical acoustic element.

17. The earthquake detection system of claim 1 wherein the upper ends of some of the vertical acoustic elements are attached directly to the top support member in a manner that does not dampen the sound emitted from the vertical acoustic element while the lower ends of the remaining vertical acoustic elements are attached directly to the base member in a manner that does not dampen the sound emitted from the vertical acoustic element.

18. The earthquake detection system of claim 1 wherein one end of each horizontal acoustic element is attached to the horizontal acoustic unit support structure and the support structure is in turn attached to the frame structure.

19. The earthquake detection system of claim 1 wherein the horizontal acoustic elements are attached to one or more of the one or more substantially vertical support members.

20. The earthquake detection system of claim 1 wherein the acoustic elements have opposed nodal points located proximate the opposed ends of the acoustic elements, and wherein each acoustic element is mounted to the frame structure at one or both of the opposed nodal points.

21. The earthquake detection system of claim 1 wherein the base structure is weighted for increased stability.

22. The earthquake detection system of claim 1 wherein the pendulum striker comprises a solid metal object.

23. An earthquake detection system comprising:
a. a frame structure comprising
i. a substantially horizontally-oriented base member,
ii. a top support member spaced apart from the base member, and
iii. one or more substantially vertical support members connected between the top support member and the base member;
b. a vertical acoustic unit comprising
i. a plurality of vertical acoustic elements, each having opposed upper and lower ends and an external striking surface capable of emitting a sound audible to humans when impacted by a pendulum striker,
ii. a support structure for mounting the plurality of vertical acoustic elements to the housing frame in a location between the top support member and the base member, the plurality of vertical acoustic elements being positioned in a substantially vertical orientation in a spaced-apart relationship at a radial distance from a first centerpoint to form a substantially cylindrical array of vertically-oriented acoustic elements, the external striking surfaces of the plurality of mounted vertical acoustic elements being directed towards the first centerpoint; and
c. a pendulum comprising a cord having an upper cord end and a lower cord end defining a cord length, the upper cord end being attached to an attachment point on the top support member inner face directly above the first centerpoint, and a pendulum striker attached to the lower cord end, the striker having a desired mass and external surface capable of causing one or more of the plurality of vertical acoustic elements to emit a sound audible to humans upon impacting the external striking surface of the one or more of the plurality of vertical acoustic elements, the cord length being sufficient to permit the pendulum striker to impact one or more of the striking surfaces of the vertical acoustic elements.

24. An earthquake detection system comprising:
a. a frame structure comprising
i. a substantially horizontally-oriented base member,
ii. a top support member spaced apart from the base member, and
iii. one or more substantially vertical support members connected between the top support member and the base member; and
b. a horizontal acoustic unit comprising
i. a plurality of horizontal acoustic elements, each having opposed ends and an external striking surface capable of emitting a sound audible to humans when impacted by a pendulum striker,
ii. a support structure for mounting the plurality of horizontal acoustic elements to the housing frame, the plurality of horizontal acoustic elements being positioned in a substantially horizontal orientation relative to the one or more substantially vertical support members in a spaced-apart relationship at a radial distance from a second centerpoint to form a substantially cylindrical array of horizontally-oriented acoustic elements, the external striking surfaces of the plurality of mounted horizontal acoustic elements being directed towards the second centerpoint; and
iii. a pendulum comprising a flexible rod having an first rod end and a second rod end defining a rod length, the first rod end being attached to an attachment point on one of the one or more substantially vertical support members in coaxial relationship with the cylindrical array of horizontally-oriented acoustic elements along the second centerpoint, and a pendulum striker attached to the second rod end, the striker having a desired mass and external surface capable of causing one or more of the plurality of horizontal acoustic elements to emit a sound audible to humans upon impacting the external striking surface of the one or more of the plurality of horizontal acoustic elements, the rod length being sufficient to permit the pendulum striker to impact one or more of the striking surfaces of the horizontal acoustic elements.
